(19) United States
(12) Patent Application Publication
(10) Pub. No.: US 2026/0203039 A1
(43) Pub. Date: Jul. 16, 2026

(54) INTELLIGENT CACHING OF OVER-THE-AIR SOFTWARE UPDATES FOR VEHICLES

(71) Applicant: MERCEDES-BENZ GROUP AG, Stuttgart (DE)

(72) Inventors: Movses BABAYAN, Monroe, WA (US); Mark MALEITZKE, Bainbridge Island, WA (US)

(21) Appl. No.: 19/134,384

(22) PCT Filed: Nov. 20, 2023
(86) PCT No.: PCT/EP2023/082444

§ 371 Date: May 30, 2025

Related U.S. Application Data
(60) Provisional application No. 63/429,480, filed on Dec. 1, 2022.

(51) Int. Cl. G06F 8/65

(52) U.S. Cl. CPC G06F 8/65

(57) ABSTRACT

An example computing system may include a control circuit configured to obtain data indicative of a vehicle identifier associated with a vehicle and a time that the vehicle is estimated to be at a location. The control circuit may be configured to determine, based on the vehicle identifier, that an over-the-air (OTA) software package is available for the vehicle. The control circuit may be configured to obtain, over a network from a remote computing system, the OTA software package for the vehicle based on the vehicle identifier. The control circuit may be configured to, prior to the time that the vehicle is estimated to be at the location, provide the OTA software package to a local cache Network(s) storage located at the location.

### RELATED APPLICATIONS

This patent application claims benefit of and priority to U.S. Provisional Patent Application No. 63/429,480 filed Dec. 1, 2022, the contents of which are hereby incorporated herein by reference in their entirety.

### FIELD

The present disclosure relates generally to distributing over-the-air software updates to vehicles. More particular, the present disclosure relates to intelligently caching over-the-air software updates at specific locations to more effectively distribute such updates to vehicles while preserving computational resources.

### BACKGROUND

Over-the-air (OTA) updates include the process of wirelessly updating the software of a device, such as a smartphone, Internet of Things (IOT) device, or vehicle. OTA updates allow manufacturers to push updates and patches to devices remotely, without requiring users to connect their device or manually install the updates. OTA updates are commonly used for fixing software bugs, improving device performance, adding new features, and addressing security vulnerabilities. OTA updates have become increasingly common in recent years as more devices are connected to the internet, making it easier for manufacturers to deliver updates quickly and efficiently.

### SUMMARY

Aspects and advantages of implementations of the present disclosure will be set forth in part in the following description, or may be learned from the description, or may be learned through practice of the implementations.

One example aspect of the present disclosure is directed to a computing system. The computing system includes a control circuit configured to obtain data indicative of a vehicle identifier associated with a vehicle and a time that the vehicle is estimated to be at a location. The control circuit is configured to determine, based on the vehicle identifier, that an over-the-air (OTA) software package is available for the vehicle. The control circuit is configured to obtain, over a network from a remote computing system, the OTA software package for the vehicle based on the vehicle identifier. The control circuit is configured to, prior to the time that the vehicle is estimated to be at the location, provide the OTA software package to a local cache storage located at the location.

In some implementations, the control circuit is further configured to determine the vehicle has arrived at the location and the vehicle is available for the OTA software package and output the OTA software package from the local cache storage.

In some implementations, to determine that the vehicle has arrived at the location and the vehicle is available for the OTA software package the control circuit is configured to obtain a request, generated by the vehicle, for the OTA software package.

In some implementations, the OTA software package includes a software update package that updates a version of software currently downloaded to the vehicle.

In some implementations, the location is a vehicle servicing location, and wherein to obtain data indicative of the time that the vehicle is estimated to arrive at the location, the control circuit is configured to obtain data indictive of a scheduled service for the vehicle and determine a time that the vehicle is estimated to arrive at the servicing location based on the scheduled service for the vehicle.

In some implementations, the location is a vehicle servicing location, and wherein to obtain data indicative of the time that the vehicle is estimated to arrive at the location, the control circuit is configured to obtain historic servicing data associated with the vehicle and predict a time that the vehicle is estimated to arrive at the servicing location based on the historic servicing data associated with the vehicle.

In some implementations, the control circuit is further configured to adjust a servicing schedule for the vehicle based on the OTA software update.

In some implementations, the location is a charging station, and to obtain data indicative of the time that the vehicle is estimated to be at the location, the control circuit is configured to obtain historic charging data associated with the vehicle, and predict a time that the vehicle is estimated to arrive at the charging station based on the historic charging data associated with the vehicle.

In some implementations, the location is a vehicle production facility, and to obtain data indicative of the time that the vehicle is estimated to be at the location, the control circuit is configured to obtain data indicating a status of the vehicle at the vehicle production facility and predict a time that the vehicle is estimated to be ready for the OTA software update at the vehicle production facility based on the status of the vehicle.

In some implementations, the control circuit is further configured to determine whether the OTA software package for the vehicle is already stored in the local cache storage located at the location.

In some implementations, the control circuit is further configured to provide, to the remote computing system for update of a shadow record of the vehicle, data indicating that the OTA software package has been provided to the vehicle at the location.

In some implementations, the control circuit is further configured to determine a confidence in the time that the vehicle is estimated to be at the location and queue the OTA software package based on the confidence in the time that the vehicle is estimated to be at the location.

In some implementations, the control circuit is further configured to obtain network traffic data associated with the network and determine a time period for obtaining the OTA software package over the network based on the network traffic data.

Another example aspect of the present disclosure is directed to a computer-implemented method system. The method includes obtaining data indicative of a vehicle identifier associated with a vehicle and a time that the vehicle is estimated to be at a location.

The method includes determining, based on the vehicle identifier, that an over-the-air (OTA) software package is available for the vehicle. The method includes obtaining, over a network from a remote computing system, the OTA software package for the vehicle based on the vehicle identifier. The method includes, prior to the time that the vehicle is estimated to be at the location, providing the OTA software package to a local cache storage located at the location.

In some implementations, the method includes determining the vehicle has arrived at the location and the vehicle is available for the OTA software package and outputting the OTA software package from the local cache storage.

In some implementations, the method includes determining whether the OTA software package for the vehicle is already stored in the local cache storage located at the location.

In some implementations, the method includes providing, to the remote computing system for update of a shadow record of the vehicle, data indicating that the OTA software package has been provided to the vehicle at the location.

In some implementations, the method includes providing, to the remote computing system for update of a shadow record of the vehicle, data indicating that the OTA software package has been provided to the vehicle at the location.

In some implementations, the method includes determining a confidence in the time that the vehicle is estimated to be at the location and queuing the OTA software package based on the confidence in the time that the vehicle is estimated to be at the location.

In some implementations, the method includes obtaining network traffic data associated with the network and determining a time period for obtaining the OTA software package over the network based on the network traffic data.

Yet another example aspect of the present disclosure is directed to one or more non-transitory computer-readable media that store instructions that are be executable by a control circuit to obtain data indicative of a vehicle identifier associated with a vehicle and a time that the vehicle is estimated to be at a location; determine, based on the vehicle identifier, that an over-the-air (OTA) software package is available for the vehicle; obtain, over a network from a remote computing system, the OTA software package for the vehicle based on the vehicle identifier; and prior to the time that the vehicle is estimated to be at the location, provide the OTA software package to a local cache storage located at the location.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIGS. 2A-D illustrate diagrams of an example computing architecture for an onboard computing system of a vehicle according to an embodiment hereof.

FIG. 3 illustrates a diagram of an example computing platform that is remote from a vehicle according to an embodiment hereof.

FIG. 4 illustrates a diagram of a computing ecosystem for providing an OTA software update for a vehicle according to an embodiment hereof.

FIG. 5 illustrates a diagram of an example update controller according to an embodiment hereof.

FIG. 6 illustrates a diagram of example computing ecosystem and dataflow for caching OTA software packages according to an embodiment hereof.

FIG. 7 illustrates a diagram of an example process for distributing and caching OTA software packages according to an embodiment hereof.

FIG. 8 illustrates a diagram of example computing ecosystem and dataflow for caching OTA software packages according to an embodiment hereof.

FIG. 9 illustrates a diagram of example computing ecosystem and dataflow for caching OTA software packages according to an embodiment hereof.

FIG. 10 illustrates a diagram of example computing ecosystem and dataflow for caching OTA software packages according to an embodiment hereof.

FIGS. 11A-C illustrate flowchart diagrams of an example method according to an embodiment hereof.

FIG. 12 illustrates a diagram of an example computing ecosystem with computing components according to an embodiment hereof.

### DETAILED DESCRIPTION

An aspect of the present disclosure relates to intelligently caching an OTA software update for a vehicle. For example, a vehicle (e.g., a personal automobile) may be scheduled for maintenance at a service location. A computing system associated with the service depot may store a data structure that indicates a maintenance schedule for the service location. The computing system may obtain, from this data structure, data indicative of the vehicle identifier for the vehicle and the time of the vehicle's appointment at the service location. The computing system may transmit a message to a cloud-based computing platform to request whether an OTA software package is available for the vehicle. A vehicle may be considered available for an OTA software package in the event that there is an OTA software update applicable for the specific vehicle to implement. For example, this can arise when an update to a version of the software running on the vehicle is made available for the vehicle's specific make and model (e.g., an infotainment software update for 2021 models). To determine whether an OTA software package is available for the vehicle, the computing system may provide the cloud-based computing platform with the vehicle's identifier (e.g., VIN).

The cloud-based computing platform may respond to the request by providing an OTA software package for the vehicle. For example, an update controller of the cloud-based computing platform may be configured to distribute OTA software packages for vehicles. Based on the vehicle identifier, the update controller may call one or more services to compile the OTA software package for transmission to the computing system associated with the service depot over a network.

The computing system may obtain the OTA software package for the vehicle and cache the OTA software packed in its local cache. For instance, prior to the time that the vehicle is estimated to be at the location, the computing system may provide the OTA software package to a local cache storage located at the service depot. The local cache storage may maintain the OTA software package such that it is queued at the appropriate time for distribution to the vehicle when it is at the service depot. For example, the vehicle may provide a request for the OTA software package (or any available OTA updates) when the vehicle arrives at the service depot. In response, the computing system may output the OTA software package from the local cache to the vehicle. The vehicle may implement the OTA software package and update the software running on the vehicle's computing system (e.g., the infotainment software), while at the service depot.

To help maintain accurate records of the vehicle's onboard software capabilities, the computing system associated with the service depot may alert the cloud-based computing system that an OTA software package was delivered to the vehicle. The cloud-based computing system may update a stored shadow record of the vehicle that reflects the current state of the software, hardware, vehicle configuration, etc. that is implemented on the vehicle. This may allow the cloud-based computing system to determine, in future instances, whether the vehicle is eligible or ineligible for a future OTA software update.

In some implementations, the computing system can cache the OTA software update based on a prediction of the vehicle's future location. For instance, the computing system can obtain historic servicing data (e.g., past maintenance records, purchase date) and predict a time that the vehicle is estimated to arrive at the service deport based on this data. This allows the computing system to leverage the data available to it to intelligently cache the OTA software updates within the servers associated with the premises, without a vehicle owner/handler expressly scheduling an appointment.

In another example, it may be predicted that the vehicle will be at a future location based on a vehicle's usage pattern. For instance, charging data associated with a particular vehicle may be obtained over time. The charging data may be collected while the vehicle is at a charging station or shortly before or after charging. The charging data may be indicative of when and where the batteries of the vehicle are charged. The charging data may be indicative of the vehicle's charge level at the start of a charging session as well as the end of the charging session. The charging data may be indicative of the duration of charging, charging speeds, charging duration, charging frequency, etc. The charging data may be communicated to a remote computing platform via the vehicle or via a computing system of a charging station.

The charging data may be processed to determine a pattern or routine of the vehicle/user that indicates the vehicle is likely to be charged at a particular charging station, on a particular day of the week, during a particular portion of the day, etc. For example, a computing system can process the charging data to determine which day the user most often charges the vehicle and/or the charge level at which the user prefers to re-charge the vehicle (e.g., below X % charge level). Additionally, or alternatively, the computing system may determine which charging stations are more frequently utilized by the vehicle for charging. This information may be used to predict when the vehicle may be located at a particular charging station so that an applicable OTA software update can be cached at the charging station, in the manner described herein.

In another example, a future location of the vehicle may be predicted based on a vehicle's route. For instance, the user of the vehicle may request a route from an origin to a destination. Given the route and the current state of charge of the vehicle, a computing system may determine where and when the vehicle may need charging. The computing system may determine candidate charging stations along the route based on when and where the vehicle may need charging. The user can be presented with the candidate charging station(s) via a user interface of the vehicle's infotainment system. In some implementations, certain candidates may be suggested for the user (e.g., visually emphasized on the UI). The user may select the candidate by providing user input to the infotainment system (e.g., a touch input). The technology of the present disclosure may be used to cache OTA software updates for the vehicle at a candidate (or selected) charging station ahead of when the vehicle arrives. In this way, the future location of the vehicle that is predicted based on the vehicle's route can be used to intelligently pre-cache OTA software updates so that the vehicle can receive them while charging.

In some implementations, the computing system associated with the service depot can calibrate the time it retrieves the OTA software package over a network based on predicted network traffic. For instance, the computing system can obtain network traffic data associated with the network over which an OTA software package would be transmitted. The network traffic data may indicate the network traffic during various time intervals throughout a day.

During an off-peak period (e.g., at night), the network traffic may be particularly low. Thus, the computing system may determine that would be an appropriate timeframe for requesting/retrieving OTA software packages to improve downlink efficiency.

While the above example is described with respect to provide OTA software updates at a service depot, the technology of the present disclosure is not limited to such locations. As will be further herein, the systems and methods for intelligently caching OTA software updates may be implemented with production facilities, factories, charging stations, etc.

The technology of the present disclosure can provide a number of technical effects and computing improvements. For instance, by intelligently caching OTA software updates for vehicles according the technology described herein, the computing ecosystem (e.g., including the onboard vehicle computer, cloud platform, etc.) can avoid other software distribution techniques that include high computational costs. For example, the systems and methods of the present disclosure avoid incurring high volume of data transfer caused by fully synchronizing all available update packages and, instead, utilizing an advance process of on-demand package synchronization. This saves time, bandwidth, processing, and memory resources by selectively retrieving only those software packages that are applicable to the particular vehicles that will be available at the local premises. Additionally, this reduces the need for disseminating physical media (e.g., DVDs) to local premises. As such, the computing ecosystem can avoid costly processing as well as inefficient read/write functions typically needed to create and utilize such media.

The technology of the present disclosure can improve the performance of a computing system that is configured to distribute software packages. For example, the computing system may obtain data indicative of a vehicle identifier (e.g., VIN) associated with a vehicle and a time that the vehicle is estimated to be at a location (e.g., an appointment time at a service depot). The computing system may determine, based on the vehicle identifier, that an over-the-air (OTA) software package is available for the vehicle. The computing system may obtain, over a network from a remote computing system, the OTA software package for the vehicle based on the vehicle identifier. Prior to the time that the vehicle is estimated to be at the location, the computing system may provide the OTA software package to a local cache storage located at the location. During the scheduled appointment, the OTA software package may be provided to the vehicle for download while at the service depot.

This in manner, the computing system is able to identify which and when a vehicle will be idle so that it may select applicable OTA software packages and locally cache them for the vehicle to retrieve. By leveraging the local cache, the computing system may more efficiently deliver the software package to a vehicle at a time in which the vehicle is not being driven by its owner. This can help ensure that an OTA software package is downloaded to the vehicle in a single session rather than multiple sessions which arise from variances in network connectivity when the vehicle is being driven to a variety of locations. As such, the technology of the present disclosure helps avoid the stopping and re-starting of OTA software packages, leading to more computationally efficient implementation of vehicle software updates. Ultimately, this can improve the performance of the vehicle itself by helping to keep the vehicle's onboard software up-to-date thereby improving the reliability of the vehicle's onboard computing functions.

Additionally, as further described herein, the technology of the present disclosure can intelligently queue OTA software packages for retrieval and/or downlink from a remote computing system. The queue can be structured in an order that avoids wasting the storage resources of a local computing system. For example, for a local computing system of a servicing depot, OTA software packages (or requests for the same) can be queued in the order that the appointments occur so that: (i) the local computing system is more likely to have the OTA software package downloaded into the local cache for the first appointment at the start of the day; (ii) any packages that are toward the back of the list to get downloaded are for appointments further out; and (iii) there is not time and bandwidth being wasted by downloading packages that are not needed.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

The technology of the present disclosure may include the collection of data associated with a user in the event that the user expressly authorizes such collection. Such authorization may be provided by the user via explicit user input to a user interface in response to a prompt that expressly requests such authorization. Collected data may be anonymized, pseudonymized, encrypted, noised, securely stored, or otherwise protected. A user may opt out of such data collection at any time.

The following description describes over-the-air (OTA) software update related technology within the context of vehicles for example purposes. The technology described herein may be utilized in other Internet of Things (IoT) contexts and environments. For example, computing devices may be used instead of vehicles and vehicle computing systems.

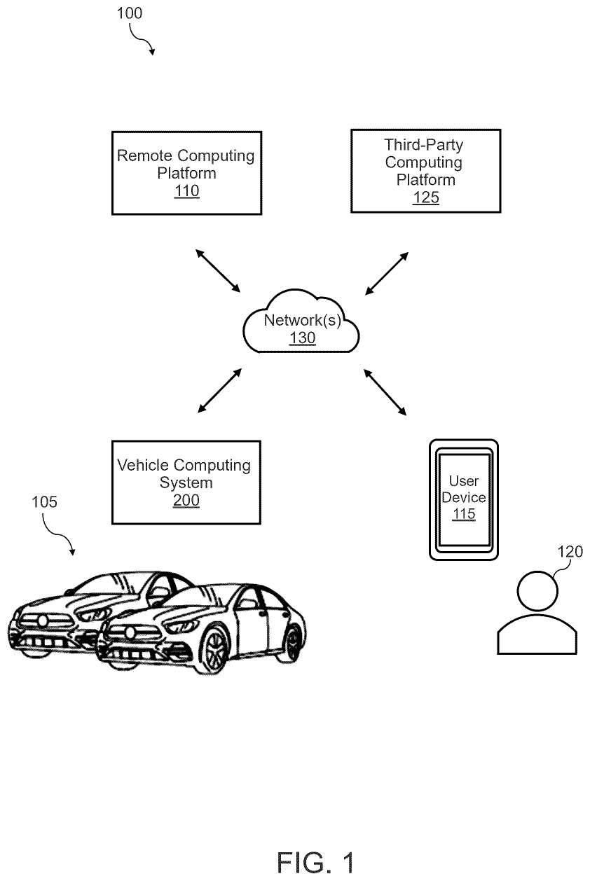

FIG. 1 illustrates an example computing ecosystem 100 according to an embodiment hereof. The ecosystem 100 may include a vehicle 105, a remote computing platform 110 (also referred to herein as computing platform 110), and a user device 115 associated with a user 120. The user 120 may be a driver of the vehicle. In some implementations, the user 120 may be a passenger of the vehicle. In some implementations, the computing ecosystem 100 may include a third party (3P) computing platform 125, as further described herein. The vehicle 105 may include a vehicle computing system 200 located onboard the vehicle 105. The computing platform 110, the user device 115, the third party computing platform 125, and/or the vehicle computing system 200 may be configured to communicate with one another via one or more networks 130.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 130 through any number of methods, such as web-based forms, programmatic access via RESTful APIs, Simple Object Access Protocol (SOAP), remote procedure call (RPC), scripting access, etc.

The computing platform 110 may include a computing system that is remote from the vehicle 105. In an embodiment, the computing platform 110 may include a cloud-based server system. The computing platform 110 may be associated with (e.g., operated by) an entity. For example, the remote computing platform 110 may be associated with an OEM that is responsible for the make and model of the vehicle 105. In another example, the remote computing platform 110 may be associated with a service entity contracted by the OEM to operate a cloud-based server system that provides computing services to the vehicle 105.

The computing platform 110 may include one or more back-end services for supporting the vehicle 105. The services may include, for example, tele-assist services, navigation/routing services, performance monitoring services, etc. The computing platform 110 may host or otherwise include one or more APIs for communicating data to/from a computing system 130 of the vehicle 105 or the user device 115.

The computing platform 110 may include one or more computing devices. For instance, the computing platform 110 may include a control circuit and a non-transitory computer-readable medium (e.g., memory). A control circuit may be one or more processors.

The control circuit of the computing platform 110 may be configured to perform the various operations and functions described herein. Further description of the computing hardware and components of computing platform 110 is provided herein with reference to other figures.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone, a camera or other imaging device, a motion sensor, etc. The user device 115 may include one or more output components such as a display device (e.g., display screen), a speaker, etc. In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith, as further described herein. In an embodiment, the launch of a software application may initiate a user-network session with the computing platform 110.

The third-party computing platform 125 may include a computing system that is remote from the vehicle 105, remote computing platform 110, and user device 115. In an embodiment, the third-party computing platform 125 may include a cloud-based server system. The term “third-party entity” may be used to refer to an entity that is different than the entity associated with the remote computing platform 110. For example, as described herein, the remote computing platform 110 may be associated with an OEM that is responsible for the make and model of the vehicle 105. The third-party computing platform 125 may be associated with a supplier of the OEM, a maintenance provider, a mapping service provider, an emergency provider, or other types of entities. In another example, the third-party computing platform 125 may be associated with an entity that owns, operates, manages, etc. a software application that is available to or downloaded on the vehicle computing system 200.

The third-party computing platform 125 may include one or more back-end services provided by a third-party entity. The third-party computing platform 125 may provide services that are accessible by the other systems and devices of the ecosystem 100. The services may include, for example, mapping services, routing services, search engine functionality, maintenance services, entertainment services (e.g., music, video, images, gaming, graphics), emergency services (e.g., roadside assistance, 911 support), or other types of services. The third-party computing platform 125 may host or otherwise include one or more APIs for communicating data to/from the third-party computing system 125 to other systems/devices of the ecosystem 100.

The networks 130 may be any type of network or combination of networks that allows for communication between devices. In some implementations, the networks 130 may include one or more of a local area network, wide area network, the Internet, secure network, cellular network, mesh network, peer-to-peer communication link or some combination thereof and may include any number of wired or wireless links. Communication over the networks 130 may be accomplished, for instance, via a network interface using any type of protocol, protection scheme, encoding, format, packaging, etc. In an embodiment, communication between the vehicle computing system 200 and the user device 115 may be facilitated by near field or short range communication techniques (e.g., Bluetooth low energy protocol, radio frequency signaling, NFC protocol).

The vehicle 105 may be a vehicle that is operable by the user 120. In an embodiment, the vehicle 105 may be an automobile or another type of ground-based vehicle that is manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a powertrain and one or more power sources. The powertrain may include a motor (e.g., an internal combustion engine, electric motor, or hybrid thereof), e-motor (e.g., electric motor), transmission (e.g., automatic, manual, continuously variable), driveshaft, axles, differential, e-components, gear, etc. The power sources may include one or more types of power sources. For example, the vehicle 105 may be a fully electric vehicle (EV) that is capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

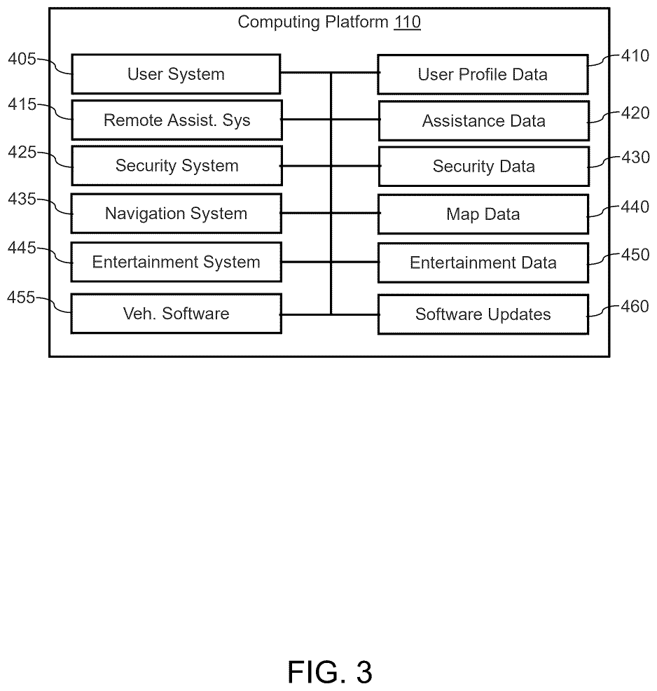

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle 105 may include a display device such as a display screen associated with an infotainment system, as further described with respect to FIG. 3.

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc.

The systems and components of the vehicle 105 may be configured to communicate via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel. The vehicle may also be configured to reference one or more protocols used for transmitting data (e.g., software updates) over a charging cable, wirelessly, via short-range communication (e.g., NFC, Bluetooth®), etc.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system 130, may act as an external buffer or repository for storing information. In such an example, the computing system 130 may retrieve or otherwise receive the information from the non-transitory computer-readable medium 140.

Certain routine and conventional components of vehicle 105 (e.g., an engine) are not illustrated and/or discussed herein for the purpose of brevity. One of ordinary skill in the art will understand the operation of conventional vehicle components in vehicle 105.

The vehicle 105 may include a vehicle computing system 200. As described herein, the vehicle computing system 200 that is onboard the vehicle 105. For example, the computing devices and components of the vehicle computing system 200 may be housed, located, or otherwise included on or within the vehicle 105. The vehicle computing system 200 may be configured to execute the computing functions and operations of the vehicle 105.

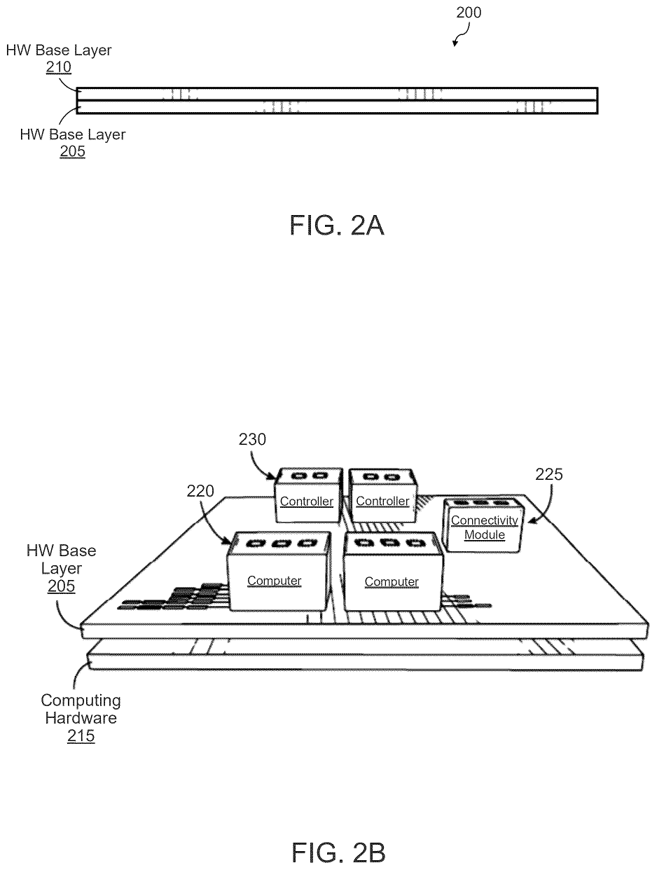

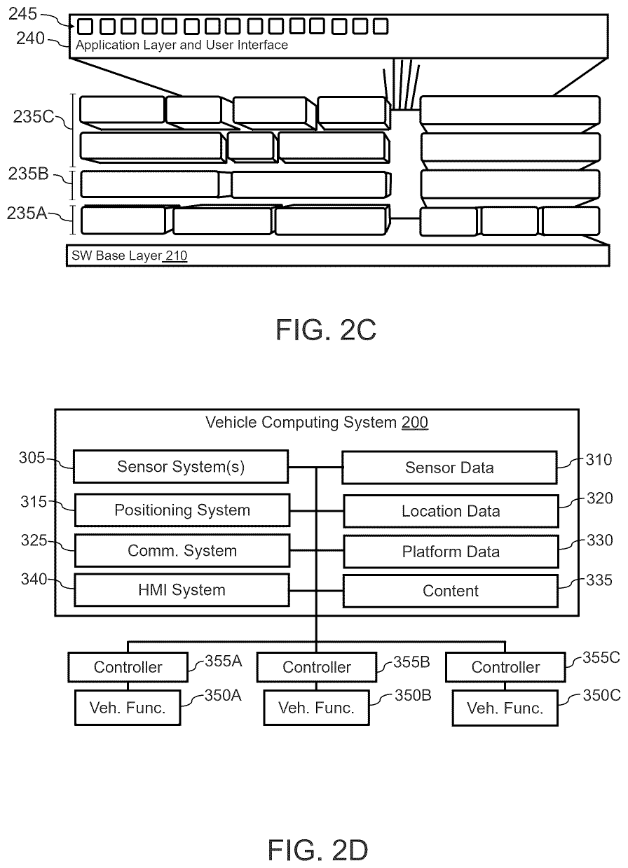

FIG. 2A illustrates an overview of an operating system of the vehicle computing system 200. The operating system may be a layered operating system. The vehicle computing system 200 may include a hardware layer 205 and a software layer 210. The hardware and software layers 205, 210 may include sub-layers. In some implementations, the operating system of the vehicle computing system 200 may include other layers (e.g., above, below, or in between those shown in FIG. 2A). In an example, the hardware layer 205 and the software layer 210 can be standardized base layers of the vehicle's operating system.

FIG. 2B illustrates a diagram of the hardware layer 205 of the vehicle computing system 200. In the layered operating system of the vehicle computing system 200, the hardware layer 205 can reside between the physical computing hardware 215 onboard the vehicle 105 and the software (e.g., of software layer 210) that runs onboard the vehicle 105.

The hardware layer 205 may be an abstraction layer including computing code that allows for communication between the software and the computing hardware 215 in the vehicle computing system 200. For example, the hardware layer 205 may include interfaces and calls that allow the vehicle computing system 200 to generate a hardware-dependent instruction to the computing hardware 215 (e.g., processors, memories, etc.) of the vehicle 105.

The hardware layer 205 may be configured to help coordinate the hardware resources. The architecture of the hardware layer 205 may be serviced oriented. The services may help provide the computing capabilities of the vehicle computing system 105. For instance, the hardware layer 205 may include the domain computers 220 of the vehicle 105, which may host various functionality of the vehicle 105 such as the vehicle's intelligent functionality. The specification of each domain computer may be tailored to the functions and the performance requirements where the services are abstracted to the domain computers. By way of example, this permits certain processing resources (e.g., graphical processing units) to support the functionality of a central in-vehicle infotainment computer for rendering graphics across one or more display devices for navigation, games, etc. or to support an intelligent automated driving computer to achieve certain industry assurances.

The hardware layer 205 may be configured to include a connectivity module 225 for the vehicle computing system 200. The connectivity module may include code/instructions for interfacing with the communications hardware of the vehicle 105. This can include, for example, interfacing with a communications controller, receiver, transceiver, transmitter, port, conductors, or other hardware for communicating data/information. The connectivity module 225 may allow the vehicle computing system 200 to communicate with other computing systems that are remote from the vehicle 105 including, for example, remote computing platform 110 (e.g., an OEM cloud platform).

The architecture design of the hardware layer 205 may be configured for interfacing with the computing hardware 215 for one or more vehicle control units 225. The vehicle control units 225 may be configured for controlling various functions of the vehicle 105. This may include, for example, a central exterior and interior controller (CEIC), a charging controller, or other controllers as further described herein.

The software layer 205 may be configured to provide software operations for executing various types of functionality and applications of the vehicle 105. FIG. 2C illustrates a diagram of the software layer 210 of the vehicle computing system 200. The architecture of the software layer 210 may be service oriented and may be configured to provide software for various functions of the vehicle computing system 200. To do so, the software layer 210 may include a plurality of sublayers 235A-E. For instance, the software layer 210 may include a first sublayer 235A including firmware (e.g., audio firmware) and a hypervisor, a second sublayer 235B including operating system components (e.g., open-source components), and a third sublayer 235C including middleware (e.g., for flexible integration with applications developed by an associated entity or third-party entity).

The vehicle computing system 200 may include an application layer 240. The application layer 240 may allow for integration with one or more software applications 245 that are downloadable or otherwise accessible by the vehicle 105. The application layer 240 may be configured, for example, using container interfaces to integrate with applications developed by a variety of different entities.

The layered operating system and the vehicle's onboard computing resources may allow the vehicle computing system 200 to collect and communicate data as well as operate the systems implemented onboard the vehicle 105. FIG. 2D illustrates a block diagram of example systems and data of the vehicle 105.

The vehicle 105 may include one or more sensor systems 305. A sensor system may include or otherwise be in communication with a sensor of the vehicle 105 and a module for processing sensor data 310 associated with the sensor configured to acquire the sensor data 305. This may include sensor data 310 associated with the surrounding environment of the vehicle 105, sensor data associated with the interior of the vehicle 105, or sensor data associated with a particular vehicle function. The sensor data 310 may be indicative of conditions observed in the interior of the vehicle, exterior of the vehicle, or in the surrounding environment. For instance, the sensor data 305 may include image data, inside/outside temperature data, weather data, data indicative of a position of a user/object within the vehicle 105, weight data, motion/gesture data, audio data, or other types of data. The sensors may include one or more: cameras (e.g., visible spectrum cameras, infrared cameras), motion sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors. The vehicle 105 may include other sensors configured to acquire data associated with the vehicle 105. For example, the vehicle 105 may include inertial measurement units, wheel odometry devices, or other sensors.

The vehicle 105 may include a positioning system 315. The positioning system 315 may be configured to generate location data 320 (also referred to as position data) indicative of a location (also referred to as a position) of the vehicle 105. For example, the positioning system 315 may determine location by using one or more of inertial sensors (e.g., inertial measurement units, etc.), a satellite positioning system, based on IP address, by using triangulation and/or proximity to network access points or other network components (e.g., cellular towers, Wi-Fi access points, etc.), or other suitable techniques. The positioning system 315 may determine a current location of the vehicle 105. The location may be expressed as a set of coordinates (e.g., latitude, longitude), an address, a semantic location (e.g., “at work”), etc.

In an embodiment, the positioning system 315 may be configured to localize the vehicle 105 within its environment. For example, the vehicle 105 may access map data that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), or other traffic signals or control devices/markings (e.g., cross walks)); or any other data. The positioning system 315 may localize the vehicle 105 within the environment (e.g., across multiple axes) based on the map data. For example, the positioning system 155 may process certain sensor data 310 (e.g., LIDAR data, camera data, etc.) to match it to a map of the surrounding environment to get an understanding of the vehicle's position within that environment. The determined position of the vehicle 105 may be used by various systems of the vehicle computing system 200 or another computing system (e.g., the remote computing platform 110, the third-party computing platform 125, the user device 115).

The vehicle 105 may include a communications system 325 configured to allow the vehicle 105 (and its vehicle computing system 200) to communicate with other computing devices. The vehicle computing system 200 may use the communications system 325 to communicate with the remote computing platform 110 or one or more other remote computing devices over a network 130 (e.g., via one or more wireless signal connections). For example, the vehicle computing system 200 may utilize the communications system 325 to receive platform data 330 from the computing platform 110. This may include, for example, an over-the-air (OTA) software update for the operating system of the vehicle computing system 200. Additionally, or alternatively, the vehicle computing system 200 may utilize the communications unit 325 to send vehicle data 335 to the computing platform 110. The vehicle data 335 may include any data acquired onboard the vehicle including, for example, sensor data 310, location data 320, diagnostic data, user input data, data indicative of current software versions or currently running applications, occupancy data, data associated with the user 120 of the vehicle 105, or other types of data obtained (e.g., acquired, accessed, generated, downloaded, etc.) by the vehicle computing system 200.

In some implementations, the communications system 325 may allow communication among one or more of the systems on-board the vehicle 105.

In an embodiment, the communications unit 325 may be configured to allow the vehicle 105 to communicate with or otherwise receive data from the user device 115 (shown in FIG. 1). The communications unit 325 may utilize various communication technologies such as, for example, Bluetooth low energy protocol, radio frequency signaling, or other short range or near filed communication technologies. The communications unit 325 may include any suitable components for interfacing with one or more networks, including, for example, transmitters, receivers, ports, controllers, antennas, or other suitable components that may help facilitate communication.

The vehicle 105 may include one or more human-machine interfaces (HMIs) 340. The human-machine interfaces 340 may include a display device, as described herein. The display device (e.g., touchscreen) may be viewable by a user of the vehicle 105 (e.g., user 120) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats). The human-machine interfaces 340 may present content 335 via a user interface for display to a user 120.

The vehicle 105 may include a plurality of vehicle functions 350A-C. A vehicle function 350A-C may be a functionality that the vehicle 105 is configured to perform based on a detected input. The vehicle functions 350A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions. The user 120 may interact with a vehicle function 250A-C through user input (e.g., to an adjustable input device, UI element) that specifies a setting of the vehicle function 250A-C selected by the user.

Each vehicle function may include a controller 355A-C associated with that particular vehicle function 355A-C. The controller 355A-C for a particular vehicle function may include control circuitry configured to operate its associated vehicle function 355A-C. For example, a controller may include circuitry configured to turn the seat heating function on, to turn the seat heating function off, set a particular temperature or temperature level, etc.

In an embodiment, a controller 355A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 120. For example, the user 120 may provide a voice command to activate the radio function of the vehicle 105 and request a particular station. The motion sensor may be a visual sensor (e.g., camera), infrared, RADAR, etc. configured to capture a gesture input from the user 120. For example, the user 120 may provide a hand gesture motion to adjust a temperature function of the vehicle 105 to lower the temperature of the vehicle interior.

The controllers 355A-C may be configured to send signals to another onboard system. The signals may encode data associated with a respective vehicle function. The encoded data may indicate, for example, a function setting, timing, etc. In an example, such data may be used to generate content for presentation via the display device 345 (e.g., showing a current setting). Additionally, or alternatively, such data can be included in vehicle data 335 and transmitted to the computing platform 110.

FIG. 3 illustrates a diagram of computing platform 110, which is remote from a vehicle according to an embodiment hereof. As described herein, the computing platform 110 may include a cloud-based computing platform. The computing platform 110 may be implemented on one or more servers and include, or otherwise have access to, one or more databases. In an example, the computing platform 110 may be implemented using different servers based on geographic region.

In some implementations, the computing platform 110 may include layered infrastructure that includes a plurality of layers. For instance, the computing platform 110 may include a cloud-based layer associated with functions such as security, automation, monitoring, and resource management. The computing platform 110 may include a cloud application platform layer associated with functions such as charging station functions, live traffic, vehicle functions, vehicle-sharing functions, etc. The computing platform 110 may include applications and services that are built on these layers.

The computing platform 110 may be a modular connected service platform that includes a plurality of services that are available to the vehicle 105. In an example, the computing platform 110 may include a container-based micro-services mesh platform. The services can be represented or implemented as systems within the computing platform 110. The computing platform 110 may also include functions relating to simulation of its components, services, and subsystems. As further described herein, this may be accomplished through the use of a test computing system that is a part of (or at least in communication with) the computing platform 110.

The computing platform 110 may include a user system 405. The user system 405 may create, store, manage, or access user profile data 410. The user profile data 410 may include a plurality of user profiles, each associated with a respective user 120. A user profile may indicate various information about a respective user 120 including the user's preferences (e.g., for music, comfort settings), frequented/past destinations, past routes, etc. The user profiles may be stored in a secure database. In some implementations, when a user 120 enters the vehicle 120, the user's key (or user device) may provide a signal with a user or key identifier to the vehicle 105. The vehicle 105 may transmit data indicative of the identifier (e.g., via its communications system 325) to the computing platform 110. The computing platform 110 may look-up the user profile of the user 120 based on the identifier and transmit user profile data 410 to the vehicle computing system 200 of the vehicle 105. The vehicle computing system 200 may utilize the user profile data 410 to implement preferences of the user 120, present past destination locations, etc. The user profile data 410 may be updated based on information periodically provided by the vehicle 105. In some implementations, the user profile data 410 may be provided to the user device 120.

The computing platform 110 may include a remote assistance system 415. The remote assistance system 415 may provide assistance to the vehicle 105. This can include providing information to the vehicle 105 to assist with charging (e.g., charging locations recommendations), remotely controlling the vehicle (e.g., for AV assistance), roadside assistance (e.g., for collisions, flat tires), etc. The remote assistance system 415 may obtain assistance data 420 to provide its core functions. The assistance data 420 may include information that may be helpful for the remote assistance system 415 to assist the vehicle 105. This may include information related to the vehicle's current state, an occupant's current state, the vehicle's location, the vehicle's route, charge/fuel level, incident data, etc. In some implementations, the assistance data 420 may include the vehicle data 335.

The remote assistance system 415 may transmit data or command signals to provide assistance to the vehicle 105. This may include providing data indicative of relevant charging locations, remote control commands to move the vehicle, connect to an emergency provider, etc.

The computing platform 110 may include a security system 425. The security system 425 can be associated with one or more security-related functions for accessing the computing platform 1110 or the vehicle 105. For instance, the security system 425 can process security data 430 for identifying digital keys, data encryption, data decryption, etc. for accessing the services/systems of the computing platform 110. Additionally, or alternatively, the security system 425 can store security data 430 associated with the vehicle 105. A user 120 can request access to the vehicle 105 (e.g., via the user device 115). In the event the request includes a digital key for the vehicle 105 as indicated in the security data 430, the security system 425 can provide a signal to lock (or unlock) the vehicle 105.

The computing platform 110 may include a navigation system 435 that provides a back-end routing and navigation service for the vehicle 105. The navigation system 435 may provide map data 440 to the vehicle 105. The map data 440 may be utilized by the positioning system 315 of the vehicle 105 to determine a location of the vehicle 105, a point of interest, etc. The navigation system 435 may also provide routes to destinations requested by the vehicle 105 (e.g., via user input to the vehicle's head unit). The routes can be provided as a portion of the map data 440 or as separate routing data. Data provided by the navigation system 435 can be presented as content on the display device 345 of the vehicle 105.

The computing platform 110 may include an entertainment system 445. The entertainment system 445 may access one or more databases for entertainment data 450 for a user 120 of the vehicle 105. In some implementations, the entertainment system 445 may access entertainment data 450 from another computing system (e.g., via an API) associated with a third-party service provider of entertainment content. The entertainment data 450 may include media content such as music, videos, gaming data, etc. The vehicle 105 may output the entertainment data 450 via one or more output devices of the vehicle 105 (e.g., display device, speaker, etc.).

The computing platform 110 may include a vehicle software system 455 that is configured to provide the vehicle 105 with one or more software updates 460. The vehicle software system 455 can include or otherwise communicate with one or more back-end services for providing software updates 460 to vehicles. For example, the vehicle software system 455 (or a service thereof) may maintain or otherwise access a data structure (e.g., list, table) that indicates the current software or versions thereof downloaded to a particular vehicle. The vehicle software system 455 (or a service thereof) may also maintain a data structure indicating software packages or versions that are to be downloaded by the particular vehicle. In some implementations, the vehicle computing system 200 may maintain a data structure that indicates the computing hardware, charging hardware, or other hardware resources onboard a particular vehicle. These data structures can be organized by vehicle identifier (e.g., VIN) such that the computing platform 110 can perform a look-up function, based on the vehicle identifier, to determine the associated software (and updates) for a particular vehicle.

When the vehicle 105 is connected to the computing platform 110 and is available to update its software, the vehicle 105 can request a software package such as, for example, a software update from the computing platform. The computing platform 110 can provide the vehicle 105 one or more software updates 460 as over-the-air (OTA) software packages (also referred to as “OTA software updates” or “OTA updates”) via a network 130. The OTA software packages (OTA updates) may include new versions of software currently downloaded to the vehicle or new software applications to be downloaded to the vehicle.

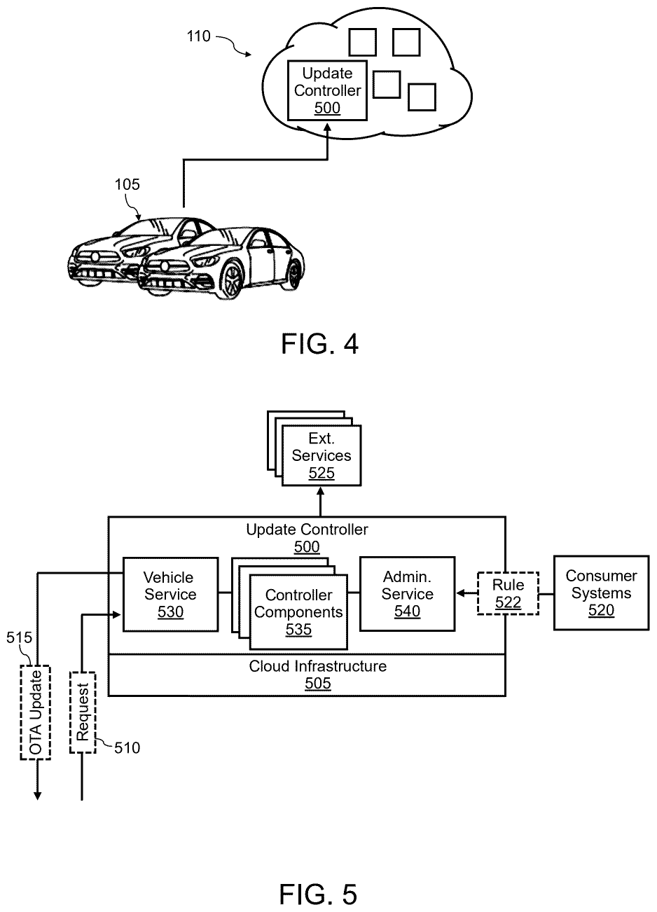

FIG. 4 illustrates a diagram of a computing ecosystem for providing an OTA software package for a vehicle 105 according to an embodiment hereof. FIG. 4 shows a portion of computing platform 110 such as, for example, the vehicle software system 455. To help orchestrate the distribution of software updates 460 (e.g., OTA updates) to vehicles, the computing platform 110 (e.g., the vehicle software system 455) may include a remote update controller system 500. The remote update controller system 500 is also referred to herein as the update controller 500. The update controller 500 may be configured to function as the orchestrator of OTA software packages as well as the point of contact for the vehicle 105 when it obtains OTA software packages.

The update controller 500 may include and communicate with various systems/components to coordinate OTA software packages. FIG. 5 illustrates a diagram of update controller 500 as well as other systems that the update controller 500 may communicate with to orchestrate the distribution of OTA software packages. FIG. 5 may represent the update controller 500 and its ecosystem within an actual, live (real-world) environment for distributing OTA software packages to actual vehicles.

The update controller 500 may be implemented on cloud computing infrastructure 505. This may include the infrastructure of the computing platform 100. The cloud computing infrastructure 505 may include the underlying framework and components that enable the delivery of cloud computing services over a network (e.g., the internet). The cloud computing infrastructure 505 may be provided by a cloud computing service provider. The cloud computing service provider may allow entities to access computing resources on-demand, adjust/consume resources as needed, etc. The cloud computing infrastructure 505 may provide the foundation for deploying and running a variety of cloud-based services, including software-as-a-service (Saas), platform-as-a-service (PaaS), and infrastructure-as-a-service (IaaS).

The cloud computing infrastructure 505 may include hardware, software, networking, and storage resources to support cloud-based applications, data storage, and processing. For instance, the cloud computing infrastructure 505 may include one or more servers. The servers may include physical or virtual machines that host and run applications, store data, and perform computational tasks in the cloud. The servers may be distributed across multiple data centers. The cloud computing infrastructure 505 may be managed and controlled through software platforms that provide functionalities such as resource provisioning, monitoring, security, and automation.

The cloud computing infrastructure 505 may include storage and networking resources. For example, the cloud computing infrastructure 505 may provide various types of storage options, such as object storage, file storage, block storage, etc. These storage resources may be accessible over a network and allow entities to store and retrieve data. The cloud computing infrastructure 505 may include networking components, such as routers, switches, and load balancers, that enable communication between different components of the cloud system. Network connectivity can ensure data transmission and accessibility across distributed servers and data centers.

The cloud computing infrastructure 505 may incorporate various security measures to protect data, applications, and infrastructure from unauthorized access, data breaches, and other threats. This includes encryption, firewalls, access controls, and security monitoring systems.

The cloud computing infrastructure 505 may utilize virtualization technology. The virtualization technology can allow for the creation of virtual instances of servers, operating systems, and other resources. This can help provide efficient resource allocation, scalability, and isolation of different cloud tenants (users or entities) on shared physical infrastructure.

The update controller 500 may communicate with a number of services and systems to manage the distribution of OTA updates. For instance, the update controller 500 may be configured to communicate with the vehicle computing system 200 (not shown in FIG. 5) of vehicle 105. The update controller 500 may receive a request (or other type of communication) generated by the vehicle computing system 500 indicating that the vehicle 105 is available for an OTA software package 515. In an example, the vehicle 105 may be considered available for an OTA software package 515 in the event that the vehicle 105 has the network connectivity to receive a package/payload associated with the OTA software package 515 and/or sufficient computing resources (e.g., processing, memory, power, etc.) needed to download and configure the OTA software package 515 on the vehicle 105.

The update controller 500 may communicate with one or more consumer systems 520. The consumer systems 520 may be computing systems configured to create a rule 522 for distributing an OTA software package 515.

The rule 522 may, for example, be associated with a campaign for updating certain software versions on a group of vehicles (e.g., certain vehicle models of year X) or a campaign for providing a new software package to a group of vehicles (e.g., a new in-vehicle chatbot for finding music content). The rule 522 may define what vehicles are subject to/applicable for a software update and what OTA update 515 is to be provided to the subject vehicles. For example, a rule 522 may be a combination of characters, text string, etc. that explicitly describes the intention to distribute a given OTA update 515 to a specific set of vehicles.

A “task” can represent the instance of a rule 522 as it applies to a discrete vehicle 105, such that when the vehicle 105 communicates with the update controller 500, the update controller 500 notifies the vehicle 105 of the task and the vehicle computing system 200 executes it. The task can include an action that that vehicle 105 is to take to implement the OTA software package 515. This can include, for example, downloading a software update package over a network, updating/changing the configuration of a component of the vehicle 105, etc.

The consumer systems 520 may automatically create a rule 522 or allow for manual creation of a rule 522. For instance, the consumer systems 520 may be configured to automatically create a rule 522 once an OTA software package 515 is validated, deployed, posted, or otherwise made available for distribution. Additionally, or alternatively, the consumer systems 520 may include a display device that is configured to present a user interface for a user of the consumer systems 520. The user interface may allow a user to provide user input to create a rule 522.

The update controller 500 may communicate with one or more external software services 525 to facilitate the distribution of an OTA software package 515 in accordance with a rule 522. The external software services 525 may also be referred to herein as “dependencies” 525. The external software services 525 may include platform-based systems such as back-end software services (e.g., microservices). The external software services 525 may include services that process or maintain information that can help determine whether a rule 522 applies to a particular vehicle 105 and the actions that are to be taken by the vehicle 105 to implement an OTA software package 515 associated with the rule 522. In an example, the dependencies 525 may include a vehicle calling service that maintains/accesses one or more data structures that include vehicle identification number (VINs) for all vehicles. The dependencies 525 may include a vehicle configuration service configured to access the vehicle configuration of a respective vehicle as well as external data associated therewith. In another example, the dependences 525 may include a vehicle document (VDOC) service. The VDOC service may include an external vehicle metadata service that maintains a record of the respective current and/or past configurations for each of the respective vehicles as well as any documentation (e.g., required by regulations).

The update controller 500 may include one or more services, components, systems, etc. that are configured to help orchestrate the OTA software package. For instance, the update controller may include a vehicle service 530 that responds to traffic from the vehicle 105. For example, the vehicle service 530 may be configured to receive a request 510 for an OTA software package 515 from a vehicle 105. The request 510 may include data that indicates the vehicle 105 is available for an OTA software package, if there is one applicable to the vehicle 105. In some implementations, the request 515 may be an explicit request for a particular (or any) OTA software package 515. The vehicle service 530 may be configured to respond to the request 510 with a payload that is indicative of the OTA software package 515 as well as the action that the vehicle 105 should take to implement the OTA software package 515.

The update controller 500 may include one or more controller components 535. The controller components 535 may be software services configured to map rules and actions to vehicle-specific tasks and carrying out a number of other related responsibilities. For example, the controller components 536 may be configured to communicate with external software services 525 or determine which external software services 525 to communicate with to gather information for a particular OTA software package 515. This may help the update controller 500 determine an action for a vehicle 105 to take with respect to a particular OTA software package 515. The controller components 535 may include, for example, a rule service (e.g., a microservice for evaluating rules), a service that is response for evaluating vehicle inventory, a device service, a data sync service, etc.

The update controller 500 may include an administration service 540 that is configured to expose an interface for consumer systems 520 to interact with the update controller 500. The administration service 540 may be configured to access data indicative of a rule 522 and interact with the controller components 535 to progress the rule 522 within the ecosystem. For example, the administration service 530 may be configured to coordinate with the rest of the update controller ecosystem such that if the vehicle service 530 were to get a request 510 from a vehicle 105 that is qualified for an OTA software package 515, the vehicle service 530 would be able to inform vehicle 105 of the action that needs to be taken for implementation of the OTA software package 515.

By way of example, the administration service 540 may obtain a rule 522 for distributing an OTA software package 515 such as, “all 2021 models are to upgrade to navigation version 6.1.6.” The update controller 500 (e.g., via the controller components 535) may communicate with the external software services 525 from which the update controller 525 can obtain information for a vehicle 105, subject to the rule 522, to properly implement the OTA software package 515. The update controller 500 may package the collected information for the subject vehicle 105 and output such information to the vehicle 105 via the vehicle service 530. This may allow vehicle computing system 200 (onboard the vehicle 105) to take the appropriate action to implement the OTA software package 515.

While the example described in FIG. 5 illustrates the services and systems that may be utilized to communicate an OTA software package 515 to a vehicle based on a request from the vehicle 105, the technology of the present disclosure improves these services/systems to intelligently determine that a vehicle 105 may be available for an OTA software package (without an explicit request from the vehicle) and communicate an OTA software package 515 to the computing system of the physical premises where the vehicle 105 is expected to be available. This can allow for the download of the OTA software package 515 by the vehicle 105 via a local cache storage that is located on the premises, at a time when the vehicle may be idle (e.g., not utilized by its owner). As further described herein, this can improve the reliability of and efficiency of delivering OTA software packages to vehicles.

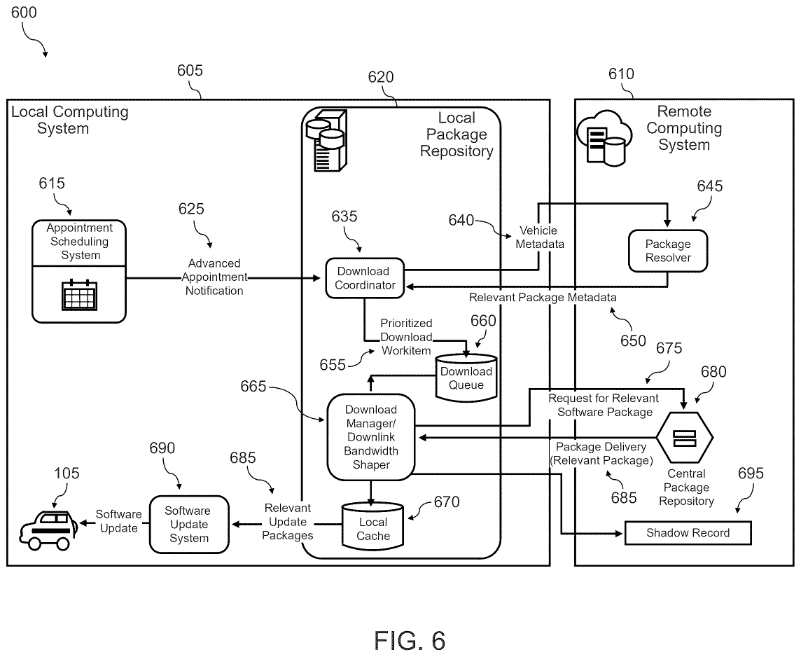

FIG. 6 illustrates a diagram of example computing ecosystem 600 and dataflow for caching OTA software packages according to an embodiment hereof. As further described herein, the computing ecosystem 600 of FIG. 6 may be used in association with a service station/depot for a vehicle. Such location is not meant to be limiting as other types of locations and facilities may utilize the described technology.

The computing ecosystem 600 may include a local computing system 605 and a remote computing system 610. The components, systems, and subsystems of FIG. 6 may be implemented as modules on computing hardware.

The local computing system 605 may be associated with a particular location. For instance, at least a portion of the local computing system 605 may be located at/on the physical premises of an entity. This may include a servicing location (e.g., service depot) for providing maintenance and other servicing to vehicles, a dealership, a vehicle distribution facility, vehicle production centers, manufacturing facilities (e.g., factories), charging stations, or other locales/entities. The local computing system 605 may include an appointment scheduling system 615 and a local package repository 620. In an example, one or both of the appointment scheduling system 615 or the local package repository 620 may be a portion of the local computing system 605 that is located at the physical premises of an entity (e.g., hosted on servers, databases, etc. located at a service depot).

The remote computing system 610 may be remote from the particular location associated with the local computing system 605. For example, the remote computing system 610 may be, be included within, or otherwise include, the computing platform 110. In some implementations, the remote computing system 610 may include the update controller 500. One or more of the components/subsystems of the remote computing system 610 described and shown in FIG. 6 may be implemented within the update controller 500.

The computing ecosystem 600 may be configured to implement a dataflow process for intelligently caching OTA software packages with the local computing system 605. For instance, the appointment scheduling system 615 may generate an appointment for the vehicle 105 to receive maintenance at a service depot. The appointment may be generated in response to a request for an appointment (e.g., by an owner/user the vehicle 105) or automatically based on historic servicing data of the vehicle 105.

The historic servicing data may indicate the history of maintenance and services performed on the vehicle 105. The appointment scheduling system 615 may analyze this data to predict/determine when it is preferred for the vehicle 105 to next receive servicing. This may be determined based on the predicted mileage of the vehicle 105 from its last servicing, its purchase, etc. Additionally, or alternatively, this may be determined based on the previous services provided (or not provided) to the vehicle 105 during its last servicing.

In some implementations, the appointment scheduling system 615 may trigger a notification indicative of the scheduled appointment. The notification may be sent to a user device 115 of a user 120 of the vehicle 105. In some implementations, the notification may be sent to the vehicle computing system 200 for the vehicle 105. The notification may be displayed (e.g., a display device) for the user 120. In some implementations, the appointment may be confirmed, denied, or modified by the user 120 providing user input in response to the notification. Data indicative of the confirmation, denial, and/or modification may be provided to the appointment scheduling system 615.

The appointment scheduling system 615 may provide an advance notification 625 to the local package repository 620. The advance notification 625 may be indicative of the date and location of the appointment (or predicted appointment). The advance notification 625 may be indicative of a time that the vehicle 105 is estimated to be at the location (e.g., servicing location). The advance notification 625 may be indicative of a vehicle identifier associated with the vehicle 105. The vehicle identifier may include, for example, a vehicle identification number.

A download coordinator 635, of the local package repository 620, may obtain the advance notification 625. The download coordinator 635 may be configured to determine whether there are any over-the-air (OTA) software packages available to the vehicle 105. For example, the download coordinator 635 may process the advance notification 625 to parse or otherwise identify the vehicle identifier for the vehicle 105. The download coordinator may determine that an OTA software package is available for the vehicle, based on the vehicle identifier.

To do so, the download coordinator 635 may communicate with the remote computing system 610. For example, the download controller 635 may transmit vehicle metadata 640 to a package resolver 645 of the remote computing system 610. The vehicle metadata 640 may be indicative of the vehicle identifier of the vehicle 105. In some implementations, the vehicle metadata 640 may include the estimated time that the vehicle 105 is expected to be at the location.

The package resolver 645 may be configured to process the vehicle metadata 640 and determine whether any OTA software packages are applicable to the vehicle 105. For instance, the package resolver 645 may include or communicate with the update controller 500, which may utilize the vehicle identifier to determine if any OTA software packages are, or will be, available for vehicle 105. This may include, for example, calling one or more external services 525, as described herein. In some implementations, the package resolver 645 may utilize the time that the vehicle 105 is estimated time to be at the servicing location to determine whether any OTA software packages that are not currently available may become so prior to the estimated arrival of the vehicle 105 at the service location. This may include, for example, any OTA updates that are pending or beta testing but are scheduled for live production prior to the estimated time the vehicle 105 is to be at the location.

The package resolver 645 may communicate relevant package metadata 650 to the local package repository 620. The relevant package metadata 650 may include information regarding one or more OTA software packages that are available for the vehicle 105. The metadata can include an identifier such as a name, link, refence number, serial number, filename, character string, etc. associated with an OTA software package. This can include, for example, an identifier associated with an OTA software package for updating the software version of an infotainment system onboard the vehicle 105. The relevant package metadata 650 may include the vehicle identifier associated with the vehicle 105.

The download coordinator 635 may receive the relevant package metadata 650. The download coordinator 635 may be a module that is configured to generate an instruction to queue a data payload for the vehicle 105. In an example, the download coordinator 635 can generate a prioritized download work item 655 based on the relevant package metadata 650. The prioritized download work item 655 may be a unit that is passed through a workflow instance associated with the download coordinator 635 (e.g., running a workflow model). The prioritized download work item 655 may contain data that the instance acts on, a reference associated with the underlying workflow step, etc. The download coordinator 635 may process the relevant package metadata 650 to identify the vehicle 105 (e.g., via the vehicle identifier) and the applicable OTA software update and then generate the prioritized download work item 655 such that it reflects this information in manner that can be processed by a downstream actor in the workflow. Moreover, the prioritized download work item 655 may include a time associated with the vehicle 105. This can indicate when the vehicle 105 is scheduled or predicted to be at the particular location associated with the local computing system 605.

The download coordinator 635 may communicate the prioritized download work item 655 to a download queue 660. The download queue 660 may be configured to process the prioritized download work item 655 to determine where to place it within a queue. The respective prioritized download work item 655 may be stored in associated with a respective vehicle identifier.

The queue may be indicative of an order, priority, etc. for each of the prioritized download work items 655 stored in the queue to be downloaded from the remote computing system 610. For example, the prioritized download work items 655 may be queued in the order in which their associated vehicles are to arrive at the particular location (e.g., servicing depot). Additionally, or alternatively, the prioritized download work items 655 may be queued based on their associated OTA software updates. For instance, the more vehicles to which a particular OTA software update applies, the higher the associated prioritized download work item 655 may be in the queue. The number of vehicles to which the OTA software update applies, can be determined based on the relevant package metadata 650 (e.g., by the download coordinator 655) or the prioritized download work items 655 (e.g., by the download queue).

In some implementations, the OTA software package can be queued based on a confidence that the vehicle 105 will arrive at the location at the scheduled/estimated time. The local computing system 605 (e.g., the download coordinator 635) can determine a confidence in the time that the vehicle 105 is estimated to be at the location and queue the OTA software package (e.g., the work item, request therefore) based on that confidence.

For example, in the event of a scheduled appointment, the confidence may be determined based on historical data indicative of arrival times, delays, cancellations, etc. of appointments associated with the vehicle 105. In the event the appointments associated with the vehicle 105 are often cancelled, the confidence in the vehicle 105 will arrive at the estimated time may be lower and the prioritized download work item 655 may be placed lower or shifted lowered in the queue. In the event that the vehicle 105 historically arrives at the servicing depot on time (rarely having cancelled appointments), the confidence in the estimated time may be higher and the prioritized download work item 655 may be moved up in the download queue 660.

In the event that the appointment is scheduled based on a predicted need for servicing, the confidence can be based on the confidence level in the prediction. For example, the local computing system 605 may determine its servicing prediction based on various signals. Certain signals may provide a stronger indicator that the vehicle 105 should receive servicing and, thus, that the vehicle 105 will arrive at the particular location. This can include, for example, the time from the last servicing and the projected mileage based on the mileage at the previous servicing. In the event that the predicted time is based more on these stronger signals, the confidence may be higher.

The download coordinator 635 and/or the download queue 660 may communicate with the download manager 665. The download manager 655 may include a control circuit configured to request the relevant OTA software package and receive the OTA software package in response to the request. The download manager 655 may access (e.g., receive from, pull from, look-up, call, obtain via, read, otherwise communicate with) the download queue 660 to determine the vehicle 105 (e.g., based on the vehicle identifier) and the available OTA software package for the vehicle 105.

Based on the information in the download queue 660 (e.g., the priority, order, etc.), the download manager 655 may access the relevant OTA software packages. By way of example, the download manager 665 may access the download queue 660 and obtain data indicative of the vehicle identifier associated with vehicle 105 and information associated with an OTA software package (e.g., an identifier thereof) that is available for vehicle 105. As described herein, this information may be stored within a prioritized download work item 655 within the download queue 660.

In some implementations, the download manager 665 may determine whether the OTA software package for the vehicle 105 is already stored in the local cache storage 670 located at the location associated with the local computing system 605. For instance, the download manager 665 may utilize the information associated with the OTA software package (e.g., the identifier thereof) to query the local cache storage 670 to determine whether the OTA software package is already stored within the local cache storage 670. In some implementations, this may include accessing a look-up table indicative of the OTA software packages that are stored within the local cache storage 670. In the event that the local cache storage 670 includes the relevant OTA software package for the vehicle 105, the download manager 665 may forgo communication with the remote computing system 610 to request the OTA software package.

In some implementations, the download manager 665 may communicate a request 675, to the remote computing system 610, for the relevant OTA software package. This may occur, for example, in the event the OTA software package is not already downloaded to the local cache storage 670. The download manager 665 may generate the request 675 based on the information associated with the OTA software package included in the download queue. This may include the relevant packages metadata 650 and/or an identifier associated with the OTA software package that can be used by the remote computing system 610 to access the OTA software package.

In an example, the remote computing system 610 may include a central package repository 680. The central package repository 680 may be configured to return the relevant OTA software package 685 based on the request 675. For example, the remote computing system 610 may be configured to access (e.g., query) the central package repository 680 using the relevant package metadata 650 (and/or other information associated with the relevant OTA software package) to obtain the OTA software package 685. The remote computing system 610 may be configured to communicate the OTA software package 685 to the download manager 665 over a network. The download manager 665 may be configured to obtain, over the network from the remote computing system 610, the OTA software package 685 for the vehicle 105.

In some implementations, the local computing system 605 may be configured to shape the downlink bandwidth for retrieving the OTA software package 685 from the remote computing system 610. In an example, the download manager 665 may be configured as the downlink bandwidth shaper. The download manager 665 may obtain network traffic data associated with a network that is utilized for communication between the local computing system 605 and the remote computing system 610. The network traffic data may indicate the historical, current, or estimated future available bandwidth, speed, outages, maintenance, etc. for the network, for one or more respective time periods of a day. The download manager 665 may determine a time period for obtaining the OTA software package 685 over the network based on the network traffic data. By way of example, the download manager 665 may determine, based on the network traffic data, that the network bandwidth and download speed is higher between 1-3 am ET and/or that retrieving the OTA software package 685 from the remote computing system 610 would be less expansive (e.g., monetarily, computationally) during this time period. As such, the download manager 665 may transmit the request 675 during 1-3 am ET such that OTA software package 685 is provided from the remote computing system 610 during this time period.

In some implementations, the download manager 665 may transmit the request 675 during a time period outside of 1-3 am ET and the request 675 may indicate a preferred time period that the download manager 665 would like to obtain the OTA software package 685 (e.g., during 1-3 am ET). In this way, the download manager 665 may transmit the lighter weight (e.g., smaller data size) request 675 during a time of higher network traffic, but receive the heavier (e.g., greater data size) OTA software package 685 during a time period of the lower network traffic.

Prior to the time that the vehicle 105 is estimated to be at the particular location associated with the local computing system 605, the download manager 665 may provide, for storage, the OTA software package 685 to the local cache storage 670. The OTA software package 685 may be stored in association with a vehicle identifier associated with vehicle 105.

This may ensure that the relevant OTA software package 685 will be available for the vehicle 105 when the vehicle 105 is at the location associated with the local computing system 605 The OTA software package 685 can be accessed by a software update system 690 when the vehicle 105 is at the particular location. For example, the software update system 690 may determine the vehicle 105 has arrived at the location and the vehicle 105 is available for the OTA software package 690. The vehicle 105 (and/or another system) may provide a communication indicating: that the vehicle 105 is ready for any available OTA software packages, that the vehicle 105 will be available to download a OTA software package for a certain time period, that the vehicle 105 is connected to a local network (e.g., wired or wireless) such that it can receive an OTA software package, the vehicle identifier associated with the vehicle 105, or other information. In some implementations, the software update system 690 may determine that the time period the vehicle 105 is available for download is enough time (e.g., given the available bandwidth, network speed, etc.) to download the OTA software package 685 from the local cache storage 670 at the location.

The software update system 690 can output, at least a portion of, the OTA software package 685 from the local cache storage 670. For example, this can include a software update that updates a version of software currently downloaded to the vehicle 105 or a new application to be added to the vehicle computing system 200.

In some implementations, the remote computing system 610 may maintain a data shadow record 695 of the vehicle 105. The data shadow record 695 may include a data structure (e.g., list, table, vehicle model) that indicates the current software version(s) onboard the vehicle 105, the software update history, locations OTA software packages were provided to/downloaded by the vehicle 105, etc. The remote computing system 610 may store the data shadow record 695 in a memory that is configured to allow the shadow record 695 to be read, written on, updated, etc. The remote computing system 610 may include a plurality of shadow records, each respectively associated with a different vehicle. The local computing system 605 (e.g., the download manager) may provide, to the remote computing system 610 for update of data shadow record 695 of the vehicle 105, data indicating that the OTA software package 685 has been provided to the vehicle 105 at the particular location.

In some implementations, the local computing system 605 may adjust a servicing schedule for the vehicle 105 based on the OTA software update 685. By way of example, the local computing system 605 (e.g., download coordinator 635, download manager 665) may determine that the OTA software package 685 is too large to download to the vehicle 105 within the currently scheduled timeframe (e.g., 30 minutes) for the vehicle 105 to be at the location. In response, the local computing system 605 (e.g., the appointment scheduling system 615) can adjust the servicing schedule to lengthen the appointment or change the appointment to another time slot and/or day that would provide for sufficient time (e.g., 60 minutes) for the vehicle 105 to download the OTA software package 685.

In some implementations, the local computing system 605 may account for changes in a schedule. This can include changes such as, for example, appointment cancellations, last minute changes, etc. The local computing system 605 may model a compensation mechanism which may de-schedule a download of an OTA software package 685, assuming it has not already started/completed. In some implementations, the OTA software package 685 may be removed from the local cache storage 670. This may occur in the event that, for example, the appointment is cancelled and has yet to be rescheduled such that it is unclear when the vehicle 105 may be at the particular location (e.g., servicing deport) and the OTA software package 685 is not relevant for another vehicle that is scheduled or predicted to be at the location.

In some implementations, the local cache may be managed based on a cache expiry using time-to-live (TTL). For example, the TTL may identify the amount of time that an OTA software package is available from the local cache 670. The TTL may be reset and/or increased each time an additional vehicle is identified as applicable to the OTA software package. For example, the TTL associated with a particular OTA software package may be “bumped” when it is determined/predicted that a vehicle, for which the OTA software package is applicable, will be at the location of the local computing system 605. Additionally, or alternatively, the TTL associated with a particular OTA software package may be “bumped” when a vehicle initiates download for the OTA software package via the local cache 670.

The local cache 670 may be purged to allow for newer OTA software packages to be included in the local cache 670. For example, newer versions of OTA software packages may be identified/requested for download in the local cache 670. Purging the local cache 670 informs the local cache 670 to stop serving the cached object associated with the older OTA software package(s) in response to vehicle requests and instead retrieve a newer object such as the newer OTA software package(s). This can help better manage the limited resources of the local cache 670.

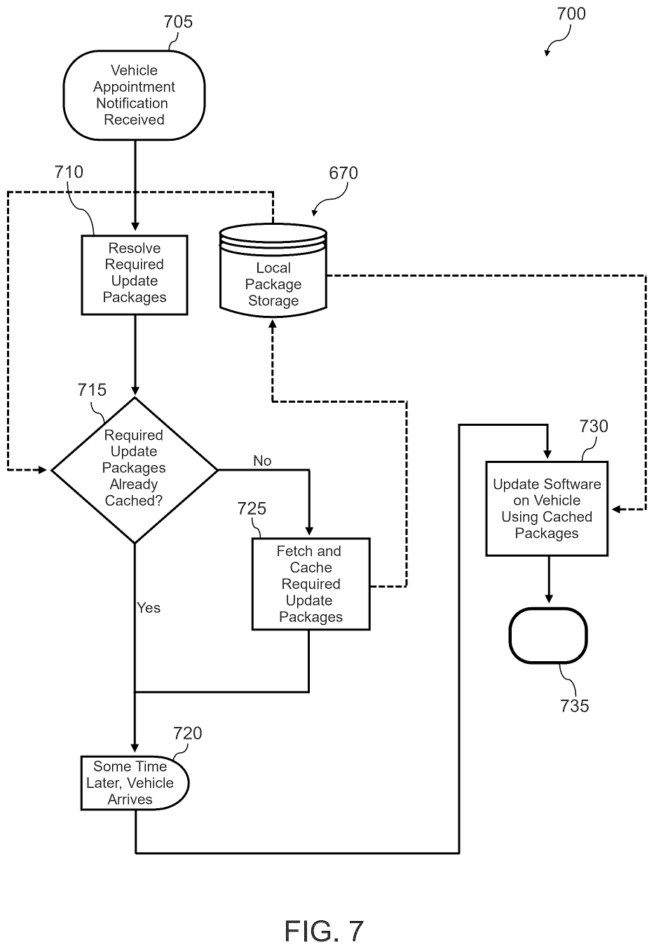

FIG. 7 illustrates a diagram of an example process 700 for distributing and caching OTA software packages according to an embodiment hereof. For example at (705), the local computing 605 may receive a vehicle appointment notification. The vehicle appointment notification may be generated based on an appointment being scheduled (and/or predicted) for the vehicle 105 at the servicing location. In some implementations, the vehicle appointment notification may be generated in response to a user (e.g., owner) associated with the vehicle 105 confirming or scheduling an appointment (e.g., via a user device).

The local computing system 605 can obtain data indicative of a vehicle identifier associated with the vehicle 105 and a time that the vehicle b 105 is estimated to be at the location (e.g., servicing location). This information can be retrieved from an accessible database of VINs and included in the notification.

At (710), the local computing system 605 can resolve any required update packages for the vehicle 105. For instance, the local computing system 605 can determine, based on the vehicle identifier, that an OTA software package 685 is available for the vehicle 105. To do so, the local computing system 605 can communicate the vehicle identifier to a remote computing 610. The remote computing system 610 (e.g., using the package resolver 645) can determine whether there are any OTA software packages available for the vehicle 105. As described herein, this can include OTA software packages that are intended for the make and model of the vehicle 105 (e.g., for an update to an infotainment software version) and have yet to be downloaded to the vehicle 105. The local computing system 605 may obtain, from the remote computing system 610, a communication that indicates the available OTA software package(s) (e.g., via metadata associated therewith) or the lack thereof.

In the event that there is at least one OTA software package 685 available for the vehicle 105, the local computing system 605 may determine whether or not the relevant OTA software package 685 is already locally cached, at (715). If so, the local computing system 605 may update a download manager 665 to associate the vehicle identifier of the vehicle 105 with the relevant OTA software package 685 in the local cache storage 670. At (720), when the vehicle 105 is at the location of the servicing depot (e.g., the local computing system 605), the local computing system can update the software on the vehicle 105 using the cached OTA software package 685, at (730). This can end the algorithmic process 700, at (735).

In the event the relevant OTA software package 685 is not already locally cached, the local computing system 605 may fetch and cache the relevant OTA software package 685 at the local cache storage 670. The local computing system 605 may obtain, over a network from the remote computing system 610, the OTA software package 685 for the vehicle 105 based on the vehicle identifier. For instance, as described herein, the local computing system 605 may (e.g., at 710) use the vehicle identifier of the vehicle 105 to determine that there is at least one OTA software package 685 that is available for the vehicle 105. This may include the local computing system 605 receiving metadata indicative of the OTA software package 685. In some implementations, the local computing system 605 may then provide a request 675 for the OTA software package 685 to the remote computing system 610. The request 675 may include metadata indicative of the OTA software package 685 and/or the vehicle identifier. In response to the request, the local computing system 605 may receive the OTA software package 685. Prior to the time that the vehicle 105 is estimated to be at the location (e.g., the servicing depot), the local computing system 605 may provide the OTA software package 685 to a local cache storage 670, which is stored on the computing hardware, physically located at the location.

At (730), the local computing system 605 may update the software on the vehicle 105 using the OTA software package 685 received from the remote computing system 610. The local computing system 610 may determine the vehicle 105 has arrived at the location and the vehicle 105 is available for the OTA software package 685. In some implementations, to make such a determination, the local computing system 605 (e.g., a software update system 690) may obtain a request, generated by the vehicle 105, for the OTA software package 685. This request may indicate the specific OTA software package 685 and/or, more generically, request any OTA software packages that are relevant/available to the vehicle 105. Additionally, or alternatively, the local computing system 605 may determine that the vehicle 105 has connected to a local network. The local computing system 605 may output the OTA software package 685 from the local cache storage 670. This can end the algorithmic process 700, at (735).

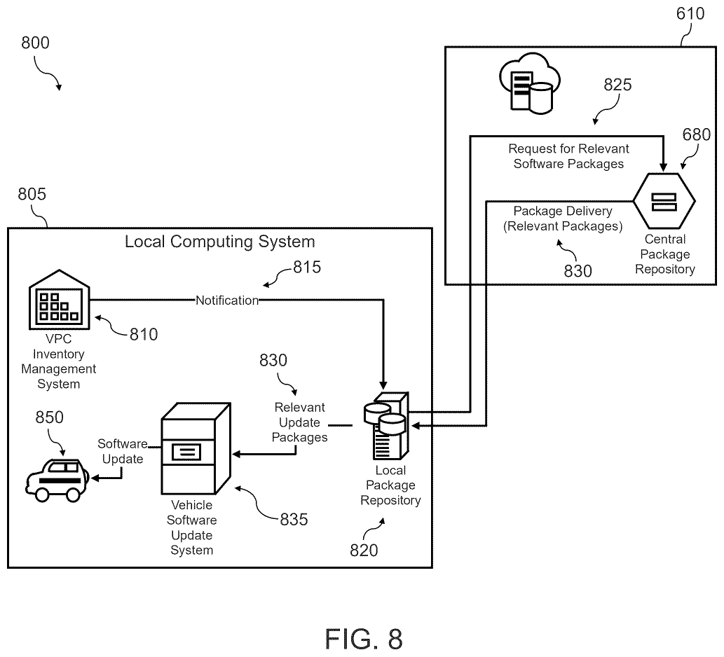

FIG. 8 illustrates a diagram of an example computing ecosystem 800 and dataflow for caching OTA software packages according to an embodiment hereof. In this example, a local computing system 805 may be located at a vehicle production center/facility (VPC).

The local computing system 805 may include a VPC inventory management system 810. The VPC inventory management system 810 may be configured to maintain a database that indicates the vehicles at the VPC, as well as a status of each vehicle. In an example, a vehicle 850 may be indicated by a vehicle identifier associated with the vehicle 850 such as the VIN. The status of a respective vehicle can be indicative of the stage, status, etc. of the respective vehicle within the VPC. This can include, for example, a status indicating the respective vehicle is ready for distribution from the vehicle production center, ready for any software updates, a time, etc. The VPC inventory management system 810 at the VPC may store the vehicle identifier for the vehicle 850 in a data structure in association with the status of the vehicle 850. The VPC inventory management system 810 may provide a notification 815 that indicates the vehicle 850 (e.g., using a vehicle identifier) and the status of the vehicle 105 within the VPC.

The local computing system 805 may predict a time that the vehicle 850 is estimated to be ready for an OTA software package at the VPC based on the status of the vehicle 850. For instance, the local computing system 805 may determine that the vehicle 850 is in a final stage at the VPC and, thus, will be ready soon to download relevant OTA software package(s).

The local computing system 805 may include a local package repository 820. The local package repository 820 may include, or otherwise be associated with, a download manager that is configured to request the relevant OTA software packages for the vehicle 850 at the VPC. To do so, the download manager may communicate a request 825 to the remote computing system 610. The request 825 may include a vehicle identifier and/or data indicative of the relevant OTA software package (e.g., relevant package metadata, reference number or other identifier). The central package repository 680 may return an OTA software package 830 that is available for and applicable to the vehicle 850. The OTA software package 830 may include one or more software updates to one or more software applications that are onboard the vehicle 830. Additionally, or alternatively, the OTA software package 830 may include a new software application for the vehicle 830, that is not currently downloaded to the vehicle 830. In some implementations, the OTA software package 830 may include software updates/packages that have been requested, allowed, purchased, etc. by a user of the vehicle 850.

The local computing system 805 may provide the OTA software package 830 to a local cache storage associated with the local package repository 830. This may occur prior to the vehicle 850 being ready to download the OTA software package 830, or at least a portion thereof.

The local computing system 805 may include a vehicle software update system 835 that can manage the distribution of the OTA software update 830 to the vehicle 850. For example, the local computing system 805 can generate an instruction for the vehicle software update system 835 to provide the OTA software package 830 (or a portion thereof) to the vehicle 850 for download. In some implementations, the vehicle software update system 835 may detect that the vehicle 850 is available for the update (e.g., because the vehicle 850 is connected to a network, a notification from another system, a request/notification from the vehicle 850) and instruct the provision of the OTA software package 830 (or a portion thereof) to the vehicle 850.

A shadow record of the vehicle 850 at the remote computing system 610 may be updated after the vehicle 850 downloads the OTA software package 830. The shadow record can indicate, at least at some point, the state of the software suite onboard the vehicle 850 when the vehicle 850 exits the VPC.

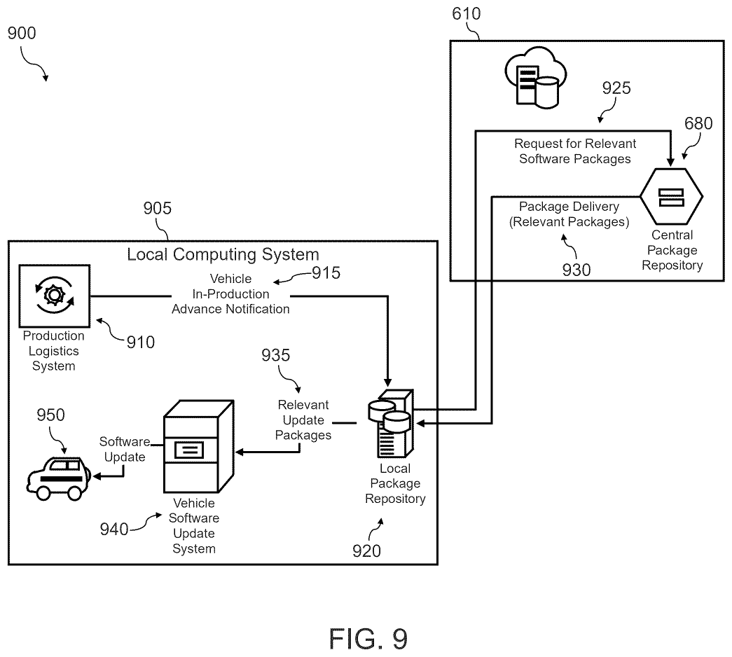

FIG. 9 illustrates a diagram of example computing ecosystem 900 and dataflow for caching OTA software packages according to an embodiment hereof. In this example, a local computing system 905 may be located at a facility such as a manufacturing facility.

The local computing system 905 may include a production logistics system 910. The production logistics system 910 may be configured to maintain a database that indicates the vehicles at the facility as well as a status of each vehicle. In an example, a vehicle 950 may be indicated by a vehicle identifier associated with the vehicle 950 such as its VIN. The status of the vehicle 950 can be indicative of the manufacturing stage, status, etc. of the vehicle 950 within the facility. This can include, for example, a status indicating the vehicle 950 is or will be ready for any software updates, a time associated therewith, etc. The production logistics system 910 may store the vehicle identifier for the vehicle 950 in a data structure in association with the status of the vehicle 950. The production logistics system 910 may provide a notification 915 that indicates the vehicle 950 (e.g., using a vehicle identifier) and the status of the vehicle 950 within the facility.

The local computing system 905 may predict a time that the vehicle 950 is estimated to be ready for an OTA software update at the facility based on the status of the vehicle 950. For instance, the local computing system 905 may determine that the vehicle 950 is in a final stage at the facility and, thus, will be ready soon to download relevant OTA software packages.

The local computing system 905 may include a local package repository 920. The local package repository 920 may include or otherwise be associated with a download manager that is configured to request the relevant OTA software packages for the vehicle 950 at the facility.

To do so, the download manager may communicate a request 925 to the remote computing system 610. As described herein, the request 925 may include a vehicle identifier and/or data indicative of the relevant OTA software package (e.g., relevant package metadata, reference number, other identifier). The central package repository 680 may return an OTA software package 930 that is available for and applicable to the vehicle 950. The OTA software package 930 may include one or more software updates to one or more software applications that are onboard the vehicle 930. Additionally, or alternatively, the OTA software package 930 may include a new software application for the vehicle 950, that is not currently downloaded to the vehicle 950. In some implementations, the OTA software package 930 may include software updates/packages that have been requested, allowed, purchased, etc. by a user of the vehicle 950.

The local computing system 905 may provide the OTA software package 930 to a local cache storage associated with the local package repository 930. In some implementations, this may occur prior to the vehicle 950 being ready to download the OTA software package 930, or at least a portion thereof.

The local computing system 905 may include a vehicle software update system 940 that can manage the distribution of the OTA software update 930 to the vehicle 950. For example, the local computing system 905 can generate an instruction for the vehicle software update system 940 to provide the OTA software package 930 (or a portion thereof) to the vehicle 950 for download. In some implementations, the vehicle software update system 940 may detect that the vehicle 950 is available for the update (e.g., because the vehicle 950 is connected to a network, a notification from another system, a request from the vehicle 950) and instruct the provision of the OTA software package 930 (or a portion thereof) to the vehicle 950.

A shadow record of the vehicle 950 at the remote computing system 610 may be updated after the vehicle 950 downloads the OTA software package 930. The shadow record can indicate, at least at some point, the state of the software suite onboard the vehicle 950 when the vehicle 950 exits the facility.

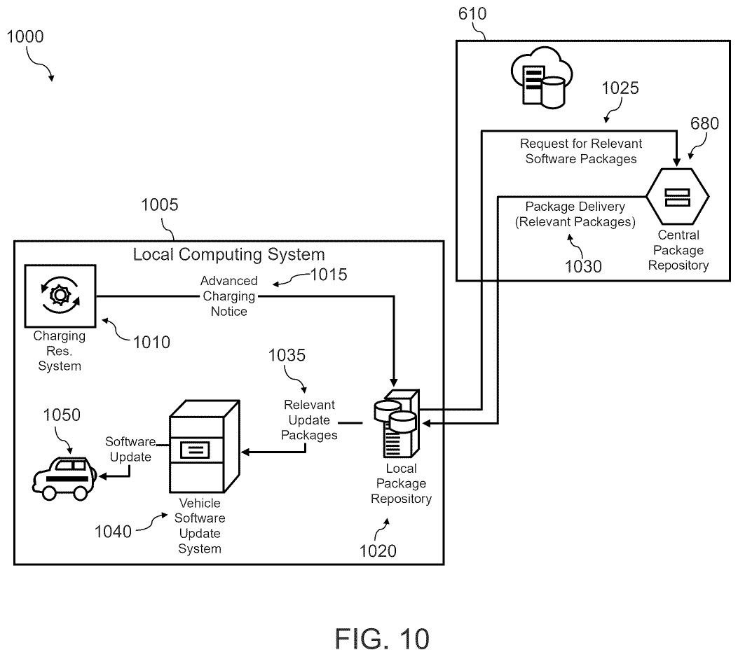

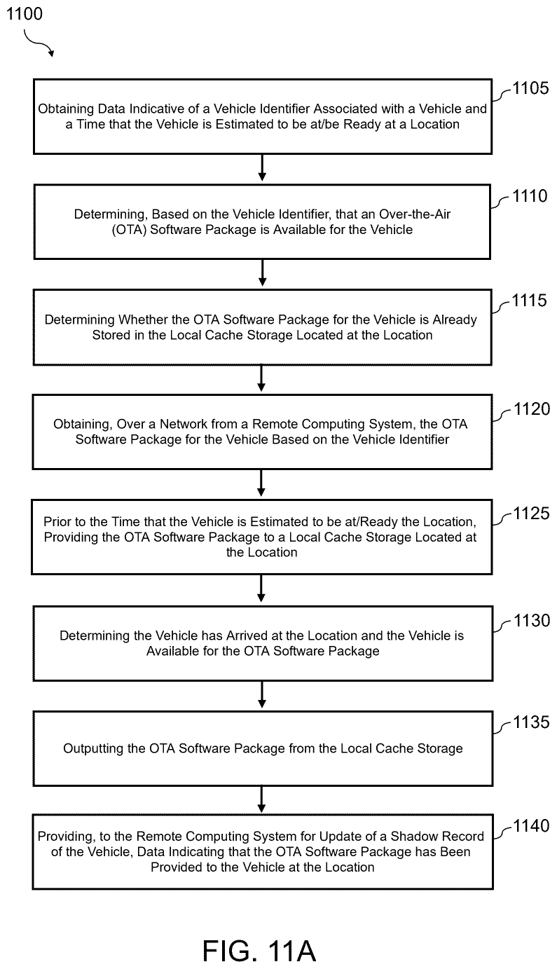

FIG. 10 illustrates a diagram of example computing ecosystem 1000 and dataflow for caching OTA software packages according to an embodiment hereof. In this example, a local computing system 1005 may be located at a charging station.

The local computing system 1005 may include a charger reservation system 1010. The charger reservation system 1010 may be configured to maintain a database that indicates the reservations/assignments of vehicles to chargers at the charging station. In an example, a vehicle 1050 may be indicated by a vehicle identifier associated with the vehicle 1050 such as its VIN. A charger reservation may be reflected as a data entry, in a data structure (e.g., table), that indicates the VIN of the vehicle 1050 in association with an identifier of the charger. The reservation may also be indicative of the time the vehicle may be utilizing the charger.

In some implementations, the charging reservation system 1010 may maintain a data structure indicating that the vehicle 1050 is to be/is predicted to be at the charging station, without a specific charger assigned to it.

In some implementations, the reservation made have been automatically made by a computing system (e.g., computing platform 110) based on a user's selection of the charging station or another type of request for the reservation.

In some implementations, the reservation may be created based on a prediction that the vehicle may be charged at the charging station at a future time. As described herein, this prediction may be based on the vehicle usage pattern indicating that a user of the vehicle typically charges the vehicle when it reaches a certain charge level. Additionally, or alternatively, the charging station may be an identified candidate for charging the vehicle when the vehicle is traveling along a particular route.

The local computing system 1005 may predict a time that the vehicle 1050 is estimated to be ready for an OTA software update at the charging station. For instance, the local computing system 1005 may determine that the vehicle 1050 will be ready to download relevant OTA software packages as soon as the vehicle 1050 is connected to the charger (e.g., via a communication link for data transfer included in the charge connector).

The local computing system 1005 may include a local package repository 1020. The local package repository 1020 may include or otherwise be associated with a download manager that is configured to request the relevant OTA software packages for the vehicle 1050 at the facility.

To do so, the download manager may communicate a request 1025 to the remote computing system 610. As described herein, the request 1025 may include a vehicle identifier and/or data indicative of the relevant OTA software package (e.g., relevant package metadata, reference number, other identifier). The central package repository 680 may return an OTA software package 1030 that is available for and applicable to the vehicle 1050. The OTA software package 1030 may include one or more software updates to one or more software applications that are onboard the vehicle 1030. Additionally, or alternatively, the OTA software package 1030 may include a new software application for the vehicle 1050, that is not currently downloaded to the vehicle 1050. In some implementations, the OTA software package 1030 may include software updates/packages that have been requested, allowed, purchased, etc. by a user of the vehicle 1050.

The OTA software package 1030 may be a size such that the vehicle 1050 is able to download the OTA software package 1030 while the vehicle 1030 is charging given the download speed of the data connection of the vehicle 1030 to the local computing system 1005. The charge time can be determined based on the predicted charge level of the vehicle 1050 when it arrives at the charging station and the speed of the assigned charger. The download manager may provide data indicative of the charge time to the remote computing system 610, which may be configured to select an OTA software package 1030 based on the charge time. This can help ensure that the OTA software package 1030 provided for the vehicle 1050 is downloadable within the time that the vehicle 1050 is charging.

The local computing system 1005 may provide the OTA software package 1030 to a local cache storage associated with the local package repository 1030. In some implementations, this may occur prior to the vehicle 1050 being ready to download the OTA software package 930, or at least a portion thereof.

The local computing system 1005 may include a vehicle software update system 1040 that can manage the distribution of the OTA software update 1030 to the vehicle 1050. For example, the local computing system 1005 can generate an instruction for the vehicle software update system 1040 to provide the OTA software package 1030 (or a portion thereof) to the vehicle 1050 for download. In some implementations, the vehicle software update system 1040 may detect that the vehicle 1050 is available for the update (e.g., because the vehicle 1050 begins charging, is connected to a network via the charger/wirelessly, a notification from another system, a request from the vehicle 1050) and instruct the provision of the OTA software package 1030 (or a portion thereof) to the vehicle 1050.

A shadow record of the vehicle 1050 at the remote computing system 610 may be updated after the vehicle 1050 downloads the OTA software package 1030. The shadow record can indicate, at least at some point, the state of the software suite onboard the vehicle 1050 when the vehicle 1050 after the OTA software package 1030 is downloaded, the vehicle 1050 is done charging, the vehicle 1050 exits the charging station, etc.

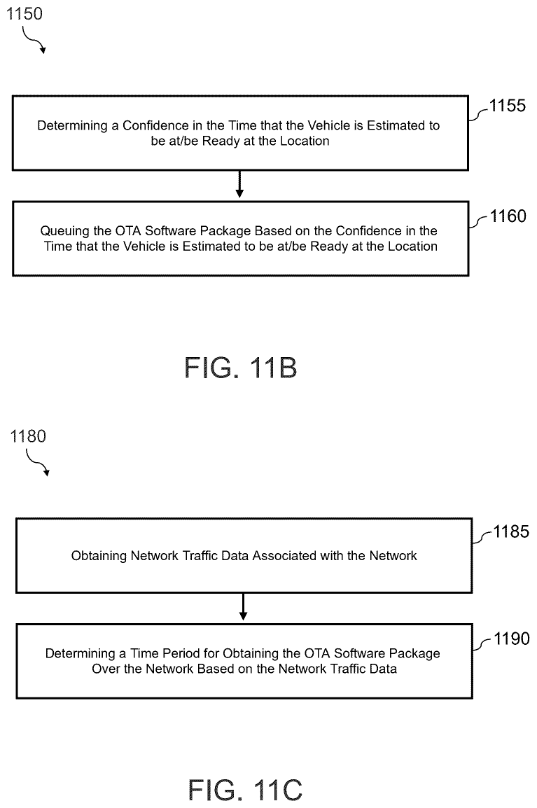

FIGS. 11A-C illustrate flowchart diagrams of example methods for distributing OTA software packages to local caches according to an embodiment hereof. The methods may be performed by a computing system described with reference to the other figures (e.g., FIGS. 1-10, 12). In an embodiment, the methods may be performed by a control circuit of a computing system. One or more portions of the methods may be implemented as an algorithm on the hardware components of the devices described herein. For example, the steps of the methods may be implemented as operations/instructions that are executable by computing hardware. This can include one or more non-transitory computer-readable media that store instructions that are executable by a control circuit to perform the operations of FIGS. 11A-C.

FIGS. 11A-C illustrate elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure.

FIGS. 11A-C are described with reference to elements/terms described with respect to other systems and figures, for example illustrated purposes and is not meant to be limiting. One or more portions of the methods may be performed additionally, or alternatively, by other systems.

In an embodiment, the method 1100 may begin with or otherwise include an operation 1105, in which a computing system may obtain data indicative of a vehicle identifier associated with a vehicle and a time that the vehicle is estimated to be at (and/or ready for package download) a location. For instance, a local computing system 605 may obtain data indicative of a vehicle identifier (e.g., VIN) associated with a vehicle 105 and a time that the vehicle 105 is estimated to be at the location associated with the local computing system 605 (and/or ready for package download).

In an example, the location associated with the local computing system may be a servicing location. The local computing system 605 may obtain data indictive of a scheduled service for the vehicle 105. The local computing system 605 may determine a time that the vehicle 105 is estimated to arrive at the servicing location based on the scheduled service for the vehicle 105. The data indicative of the scheduled service may be an appointment notification that includes the vehicle identifier for the vehicle 105.

Additionally, or alternatively, the local computing system 605 may obtain historic servicing data associated with the vehicle 105. The historic servicing data may indicate past maintenance or service records of the vehicle 105, services that have not yet been completed, dates of services, types of service, etc. The local computing system 605 may predict a time that the vehicle 105 is estimated to arrive at the servicing location based on the historic servicing data associated with the vehicle 105. For example, the historic servicing data may indicate that the vehicle 105 received an oil change 14 months ago and, at that time, the vehicle's mileage was 24,000 miles. The historic servicing data may indicate that, on average, the vehicle 105 receives an oil change every 3000 miles and that the vehicle 105 drives approximately 200 miles per month. Thus, the local computing system 605 may determine that the vehicle 105 is estimated to arrive at the servicing location within the next month.

In an example, the location associated with the local computing system 605 may be a charging station. For instance, the vehicle 105 may be an electric-power vehicle (EV). The local computing system 605 may be configured to obtain historic charging data associated with the vehicle 105 and predict a time that the vehicle 105 is estimated to arrive at the charging station based on the historic charging data associated with the vehicle 105. For example, the historic charging data may indicate when, where, and how often the vehicle 105 charges its batteries. The local computing system 605 may utilize this information to predict that the vehicle 105 may be arriving at the charging station within a certain timeframe of the week.

The method 1100 in an embodiment may include an operation 1110, in which the computing system may determine, based on the vehicle identifier, that an over-the-air (OTA) software package is available for the vehicle. For instance, the local computing system 605 may determine, based on the vehicle identifier associated with the vehicle 105, that an OTA software package is available for the vehicle 105. As described herein, this can include providing a communication indicative of the vehicle identifier to a remote computing system 610. The remote computing system 610 may access its databases, etc. to determine if there are any relevant OTA software packages for the vehicle 105 (e.g., based on its make/model/year). The remote computing system 610 may respond to the local computing system 605 to indicate the OTA software package(s), if any, available to the vehicle 105. This can include transmitting data indicative the reference number, link, and/or another type of identifier associated with one or more OTA software packages.

The method 1100 in an embodiment may include an operation 1115, in which the computing system may determine whether the OTA software package for the vehicle is already stored in the local cache storage 670 located at the location. For instance, the local computing system 605 may access its local cache storage 670 to determine whether the OTA software package that is relevant and available for the vehicle 105 is already locally cached. To do so, the local computing system 605 may generate a search query and/or perform a look-up function in the local cache using an identifier associated with the OTA software package (e.g., a reference number, serial number, name). In the event that the local cache storage 670 already includes the OTA software package, the local computing system 605 may provide an instruction to associate a vehicle identifier of the vehicle 105 with that OTA software package. This may include making a data entry, completing data field(s), etc. to indicate that the OTA software package should be distributed to the vehicle 105 associated with the particular vehicle identifier.

If the OTA software package is already locally cached, the local computing system 605 may not request the OTA software package from the remote computing system 610.

In some instances, the OTA software package may not already be stored in the local cache storage.

In an embodiment, the method 1100 may include an operation 1120, in which the computing system may obtain, over a network from a remote computing system, the OTA software package for the vehicle based on the vehicle identifier. For instance, the local computing system 605 may provide a first communication to the remote computing system 610 inquiring whether there are any relevant OTA software packages for the vehicle 105. The first communication may include the vehicle identifier associated with the vehicle 105. The remote computing system 610 can process this request and perform a look-up function, using the vehicle identifier, to determine the make and model and year of the vehicle 105. The remote computing system 610 can determine whether there are any outstanding OTA software packages that are available for the vehicle 105 (e.g., its given make, model, year) and that have not already been downloaded to the vehicle 105.

In some implementations, the remote computing system 610 can use an identifier associated with the vehicle 105 to query a database storing a shadow record of the vehicle 105. The remote computing system 610 can utilize the shadow record to determine if the onboard software of the vehicle 105 is up-to-date and/or whether any OTA software packages are available to it. For example, the shadow record may indicate the current version of infotainment software running on the vehicle 105. The remote computing system 610 may determine that there is a newer version of the infotainment software for the make/model/year of vehicle 105.

In some implementations, in response to the first communication inquiring whether there are any relevant OTA software packages for the vehicle 105, the remote computing system 610 can identify a relevant OTA software package and transmit it to the vehicle 105.

In some implementations, the remote computing system 610 may transmit data indicative of the relevant OTA software package to the local computing system 605. This data may be sent instead of the OTA software package itself. For example, the remote computing system 610 may transmit metadata indicative of the OTA software package (e.g., infotainment software update) to the local computing system 605. The metadata can include an identifier associated with the OTA software package.

The local computing system 610 can generate a second communication requesting the OTA software package. In an example, the local computing system 610 can call an API and structure the second communication according to the API to request the OTA software package from a database (e.g., the central package repository 680). The remote computing system 610 can process the structured request and return the OTA software package to the local computing system 605.

By generating the separate first and second communications for identifying and then obtaining the OTA software package, respectively, technical effects and improvements can be recognized by the present disclosure. For instance, in response to the first communication requesting whether there are any relevant OTA software packages for the vehicle 105, the local computing system 605 may obtain a smaller data packet that includes an identifier associated with the relevant OTA software package rather than the package itself. This allows the local computing system 605 to store less information in a structured queue and control the timing for acquiring the actual OTA software package. By utilizing this approach, the local computing system 605 can preserve its memory resources (e.g., by storing the lighter weight metadata) while still ensuring that the OTA software package is locally cached for the vehicle 105.

In some implementations, the computing system may obtain the OTA software package based on the network traffic associated with the network via which the OTA software package is obtained. This may include the operations of method 1180 shown in FIG. 11C. For instance, at 1185, the local computing system 605 may obtain network traffic data associated with the network. This network traffic data may be obtained by calling an API of a third-party network monitoring service and sending a request for such data that is structured based on the API. In response, the local computing system 605 may obtain (e.g., from the third party computing system) the network traffic data indicating the current bandwidth, download speeds, etc. of the network.

At 1190, the local computing system 605 may determine a time period for obtaining the OTA software package over the network based on the network traffic data. The time period can be one where there is enough bandwidth, download speed, etc. to efficiently transmit the OTA software package over the network. This may also be a time period where the transmission would be the most cost effective (e.g., price per MB). This configuration for evaluating the network in this manner can be reflected in the local computing system 605, which may have a model having a component that is responsible for shaping the downlink traffic.

Returning to FIG. 11A, in an embodiment, the method 1000 may include an operation 1125, in which the computing system may, prior to the time that the vehicle is estimated to be at the location, provide the OTA software package to a local cache storage located at the location. For instance, in some implementations, the local computing system 605 may provide the OTA software package to the local cache storage ahead of a time that the vehicle 105 may request/be available for the OTA software package.

In some implementations, the local computing system 605 may send the request to the remote computing system 610 at a time such that the local computing system 605 may provide the OTA software package to the local cache storage ahead of the vehicle 105 arriving at the location or otherwise being ready/available to download it.

In some implementations, the OTA software package may be queued based on a confidence that the vehicle 105 will be at the location (e.g., servicing depot, VPC, charging station, factory) at the scheduled/estimated time. This may include the operations of method 1150 shown in FIG. 11B. For instance, at 1155, the local computing system 605 may determine a confidence in the time that the vehicle is estimated to be at/be ready at the location, as described herein. The local computing system 605 may queue the OTA software package based on the confidence in the time that the vehicle is estimated to be at the location, at 1160. For example, the higher the confidence the vehicle 105 will arrive sooner, the higher a work item for downloading the OTA software package to the local cache can be in a queue.

Returning to FIG. 11A, in an embodiment, the method 1100 may include an operation 1130, in which the computing system may determine the vehicle has arrived at the location and the vehicle is available for the OTA software package. For instance, the local computing system 605 may obtain a request, generated by the vehicle 105, for the OTA software package. This request may indicate the specific package or any relevant packages for the vehicle 105. Additionally, or alternatively, the local computing system 605 may determine the vehicle 105 has arrived at the location (e.g., charging station, servicing location) based on the vehicle 105 connecting to a network associated with the location. Additionally, or alternatively, a computing device of the vehicle 105 may broadcast its presence (e.g., via near field communication, other network communication) to the local computing system 605 and/or other computing devices.

In an embodiment, the method 1100 may include an operation 1135, in which the computing system may output the OTA software package from the local cache storage. By way of example, the local computing system 605 may provide an instruction to release an OTA software update for the vehicle's infotainment software, from the local cache storage. This can allow the vehicle 105 to download the infotainment software update from the local cache storage, rather than from a remote cloud platform.

In an embodiment, the method 1100 may include an operation 1140, in which the computing system may provide, to the remote computing system for update of a shadow record of the vehicle, data indicating that the OTA software package has been provided to the vehicle at the location. By way of example, data indicating that the vehicle 105 downloaded the software update for its infotainment system and the version number associated therewith, can be provided for updating the shadow record of the vehicle 105 (e.g., stored by the remote computing system 610). In some implementations, the shadow record may be maintained onboard the vehicle 105 and/or within the local computing system 605 and periodically uploaded to the remote computing system 610.

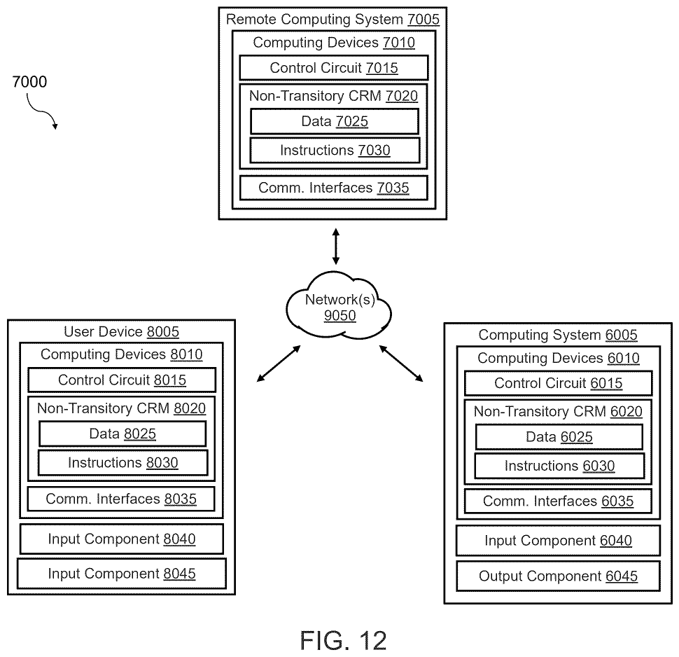

FIG. 12 illustrates a block diagram of an example computing system 7000 according to an embodiment hereof. The system 7000 includes a computing system 6005 (e.g., a computing system onboard a vehicle), a remote computing system 7005 (e.g., a server computing system, a cloud computing platform, a testing computing system, etc. that is remote from the vehicle), and a user device 8005 (e.g., user device of a vehicle user) that are communicatively coupled over one or more networks 9050. The computing system 6005, remote computing system 7005, user device 8005, and networks 9050 may represent the systems (and the components of those systems) and networks described herein with reference to other figures.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 620 may store computer-executable instructions or computer-readable instructions, such as instructions to perform at least a portion of the method of FIGS. 11A-C.

The computing system 6005 may include one or more communication interfaces 6035. The communication interfaces 6035 may be used to communicate with one or more other systems. The communication interfaces 6035 may include any circuits, components, software, etc. for communicating via one or more networks (e.g., networks 750). In some implementations, the communication interfaces 6035 may include for example, one or more of a communications controller, receiver, transceiver, transmitter, port, conductors, software and/or hardware for communicating data/information.

The computing system 6005 may also include one or more user input components 6040 that receives user input. For example, the user input component 6040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6045. The output components 6045 may include hardware and/or software for audibly or visually producing content. For instance, the output components 6045 may include one or more speakers, earpieces, headsets, handsets, etc. The output components 6045 may include a display device, which may include hardware for displaying a user interface and/or messages for a user. By way of example, the output component 6045 may include a display screen, CRT, LCD, plasma screen, touch screen, TV, projector, tablet, and/or other suitable display components.

The remote computing system 7005 may include one or more computing devices 710. In an embodiment, the remote computing system 7005 may include or is otherwise implemented by one or more server computing devices. In instances in which the remote computing system 7005 includes plural server computing devices, such server computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), or a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the remote computing system 7005 may obtain data from one or more memories that are remote from the remote computing system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. This may include the operations described as being performed by the test computing system 610. In some cases, the non-transitory computer-readable medium 7020 may store computer-executable instructions or computer-readable instructions, such as instructions to perform at least a portion of the dataflows and methods/processes of FIGS. 5-11C.

The server computing system 7005 may include one or more communication interfaces 7035. The communication interfaces 7035 may be used to communicate with one or more other systems. The communication interfaces 7035 may include any circuits, components, software, etc. for communicating via one or more networks (e.g., networks 9050). In some implementations, the communication interfaces 7035 may include for example, one or more of a communications controller, receiver, transceiver, transmitter, port, conductors, software and/or hardware for communicating data/information.

The computing system 6005 and/or the server computing system 7005 may also be in communication with a user device 8005 that is communicatively coupled over the networks 9050.

The user device 8005 may include one or more computing devices 8010. The user device 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 820 (e.g., memory devices) may store data 8025 that may be obtained, received, accessed, written, manipulated, created, and/or stored. The data 8025 may include, for instance, any of the data or information described herein. In some implementations, the user device 8005 may obtain data from one or more memories that are remote from the user device 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIGS. 11A-C.

The user device 8005 may include one or more communication interfaces 8035. The communication interfaces 8035 may be used to communicate with one or more other systems. The communication interfaces 8035 may include any circuits, components, software, etc. for communicating via one or more networks (e.g., networks 9050). In some implementations, the communication interfaces 8035 may include for example, one or more of a communications controller, receiver, transceiver, transmitter, port, conductors, software and/or hardware for communicating data/information.

The user device 8005 may also include one or more user input components 840 that receives user input. For example, the user input component 8040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The user device 8005 may include one or more output components 8045. The output components 8045 may include hardware and/or software for audibly or visually producing content. For instance, the output components 8045 may include one or more speakers, earpieces, headsets, handsets, etc. The output components 8045 may include a display device, which may include hardware for displaying a user interface and/or messages for a user. By way of example, the output component 8045 may include a display screen, CRT, LCD, plasma screen, touch screen, TV, projector, tablet, and/or other suitable display components.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### Additional Discussion of Various Embodiments

Embodiment 1 relates to a computing system. In this embodiment, the computing system may include a control circuit configured to obtain data indicative of a vehicle identifier associated with a vehicle and a time that the vehicle is estimated to be at a location. The control circuit may be configured to determine, based on the vehicle identifier, that an over-the-air (OTA) software package is available for the vehicle. The control circuit may be configured to obtain, over a network from a remote computing system, the OTA software package for the vehicle based on the vehicle identifier. The control circuit may be configured to, prior to the time that the vehicle is estimated to be at the location, provide the OTA software package to a local cache storage located at the location.

Embodiment 2 includes the computing system of Embodiment 1. In this embodiment, the control circuit may be further configured to determine the vehicle has arrived at the location and the vehicle is available for the OTA software package and output the OTA software package from the local cache storage.

Embodiment 3 includes the computing system of any of Embodiments 1 and 2. In this embodiment, to determine that the vehicle has arrived at the location and the vehicle is available for the OTA software package the control circuit may be configured to obtain a request, generated by the vehicle, for the OTA software package.

Embodiment 4 includes the computing system of any of Embodiments 1-3. In this embodiment, the OTA software package may include a software update package that updates a version of software currently downloaded to the vehicle.

Embodiment 5 includes the computing system of any of Embodiments 1-4. In this embodiment, the location may be a vehicle servicing location, and wherein to obtain data indicative of the time that the vehicle is estimated to arrive at the location, the control circuit may be configured to obtain data indictive of a scheduled service for the vehicle and determine a time that the vehicle is estimated to arrive at the servicing location based on the scheduled service for the vehicle.

Embodiment 6 includes the computing system of any of Embodiments 1-5. In this embodiment, the location may be a vehicle servicing location, and wherein to obtain data indicative of the time that the vehicle is estimated to arrive at the location, the control circuit may be configured to obtain historic servicing data associated with the vehicle and predict a time that the vehicle is estimated to arrive at the servicing location based on the historic servicing data associated with the vehicle.

Embodiment 7 includes the computing system of any of Embodiments 1-6. In this embodiment, the control circuit may be further configured to adjust a servicing schedule for the vehicle based on the OTA software update.

Embodiment 8 includes the computing system of any of Embodiments 1-7. In this embodiment, the location may be a charging station, and wherein to obtain data indicative of the time that the vehicle is estimated to be at the location, the control circuit may be configured to obtain historic charging data associated with the vehicle, and predict a time that the vehicle is estimated to arrive at the charging station based on the historic charging data associated with the vehicle.

Embodiment 9 includes the computing system of any of Embodiments 1-8. In this embodiment, the location may be a vehicle production facility, and wherein to obtain data indicative of the time that the vehicle is estimated to be at the location, the control circuit may be configured to obtain data indicating a status of the vehicle at the vehicle production facility and predict a time that the vehicle is estimated to be ready for the OTA software update at the vehicle production facility based on the status of the vehicle.

Embodiment 10 includes the computing system of any of Embodiments 1-9. In this embodiment, the control circuit may be further configured to determine whether the OTA software package for the vehicle is already stored in the local cache storage located at the location.

Embodiment 11 includes the computing system of any of Embodiments 1-10. In this embodiment, the control circuit may be further configured to provide, to the remote computing system for update of a shadow record of the vehicle, data indicating that the OTA software package has been provided to the vehicle at the location.

Embodiment 12 includes the computing system of any of Embodiments 1-11. In this embodiment, the control circuit may be further configured to determine a confidence in the time that the vehicle is estimated to be at the location and queue the OTA software package based on the confidence in the time that the vehicle is estimated to be at the location.

Embodiment 13 includes the computing system of any of Embodiments 1-12. In this embodiment, the control circuit may be further configured to obtain network traffic data associated with the network and determine a time period for obtaining the OTA software package over the network based on the network traffic data.

Embodiment 14 relates to a computer-implemented method system. In this embodiment, the method may include obtaining data indicative of a vehicle identifier associated with a vehicle and a time that the vehicle is estimated to be at a location. The method may include determining, based on the vehicle identifier, that an over-the-air (OTA) software package is available for the vehicle. The method may include obtaining, over a network from a remote computing system, the OTA software package for the vehicle based on the vehicle identifier. The method may include, prior to the time that the vehicle is estimated to be at the location, providing the OTA software package to a local cache storage located at the location.

Embodiment 14 includes the computer-implemented method of Embodiments 13. In this embodiment, the method may include determining the vehicle has arrived at the location and the vehicle is available for the OTA software package and outputting the OTA software package from the local cache storage.

Embodiment 15 includes the computer-implemented method of any of Embodiments 13 or 14. In this embodiment, the method may include determining whether the OTA software package for the vehicle is already stored in the local cache storage located at the location.

Embodiment 16 includes the computer-implemented method of any of Embodiments 13-15. In this embodiment, the method may include providing, to the remote computing system for update of a shadow record of the vehicle, data indicating that the OTA software package has been provided to the vehicle at the location.

Embodiment 17 includes the computer-implemented method of any of Embodiments 13-16. In this embodiment, the method may include providing, to the remote computing system for update of a shadow record of the vehicle, data indicating that the OTA software package has been provided to the vehicle at the location.

Embodiment 18 includes the computer-implemented method of any of Embodiments 13-17. In this embodiment, the method may include determining a confidence in the time that the vehicle is estimated to be at the location and queuing the OTA software package based on the confidence in the time that the vehicle is estimated to be at the location.

Embodiment 19 includes the computer-implemented method of any of Embodiments 13-18. In this embodiment, the method may include obtaining network traffic data associated with the network and determining a time period for obtaining the OTA software package over the network based on the network traffic data.

Embodiment 20 relates to one or more non-transitory computer-readable media that store instructions that may be executable by a control circuit to obtain data indicative of a vehicle identifier associated with a vehicle and a time that the vehicle is estimated to be at a location; determine, based on the vehicle identifier, that an over-the-air (OTA) software package is available for the vehicle; obtain, over a network from a remote computing system, the OTA software package for the vehicle based on the vehicle identifier; and prior to the time that the vehicle is estimated to be at the location, provide the OTA software package to a local cache storage located at the location.

### Additional Disclosure

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

Computing tasks and operations discussed herein as being performed at or by computing device(s) remote from the vehicle can instead be performed at the vehicle (e.g., via the vehicle computing system), or vice versa.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . ., (i), (ii), (iii), ..., etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

1. A computing system comprising:
a control circuit configured to:
obtain data indicative of a vehicle identifier associated with a vehicle and a time that the vehicle is estimated to be at a location;
determine, based on the vehicle identifier, that an over-the-air (OTA) software package is available for the vehicle;
obtain, over a network from a remote computing system, the OTA software package for the vehicle based on the vehicle identifier; and
prior to the time that the vehicle is estimated to be at the location, provide the OTA software package to a local cache storage located at the location.

2. The computing system of claim 1, wherein the control circuit is further configured to:
determine the vehicle has arrived at the location and the vehicle is available for the OTA software package; and
output the OTA software package from the local cache storage.

3. The computing system of claim 2, wherein to determine that the vehicle has arrived at the location and the vehicle is available for the OTA software package the control circuit is configured to:
obtain a request, generated by the vehicle, for the OTA software package.

4. The computing system of claim 1, wherein the OTA software package comprises a software update package that updates a version of software currently downloaded to the vehicle.

5. The computing system of claim 1, wherein the location is a vehicle servicing location, and wherein to obtain data indicative of the time that the vehicle is estimated to arrive at the location, the control circuit is configured to:
obtain data indictive of a scheduled service for the vehicle; and
determine a time that the vehicle is estimated to arrive at the servicing location based on the scheduled service for the vehicle.

6. The computing system of claim 1, wherein the location is a vehicle servicing location, and wherein to obtain data indicative of the time that the vehicle is estimated to arrive at the location, the control circuit is configured to:
obtain historic servicing data associated with the vehicle; and
predict a time that the vehicle is estimated to arrive at the servicing location based on the historic servicing data associated with the vehicle.

7. The computing system of claim 1, wherein the control circuit is further configured to:
adjust a servicing schedule for the vehicle based on the OTA software update.

8. The computing system of claim 1, wherein the location is a charging station, and wherein to obtain data indicative of the time that the vehicle is estimated to be at the location, the control circuit is configured to:
obtain historic charging data associated with the vehicle; and
predict a time that the vehicle is estimated to arrive at the charging station based on the historic charging data associated with the vehicle.

9. The computing system of claim 1, wherein the location is a vehicle production facility, and wherein to obtain data indicative of the time that the vehicle is estimated to be at the location, the control circuit is configured to:
obtain data indicating a status of the vehicle at the vehicle production facility; and
predict a time that the vehicle is estimated to be ready for the OTA software update at the vehicle production facility based on the status of the vehicle.

10. The computing system of claim 1, wherein the control circuit is further configured to:
determine whether the OTA software package for the vehicle is already stored in the local cache storage located at the location.

11. The computing system of claim 1, wherein the control circuit is further configured to:
provide, to the remote computing system for update of a shadow record of the vehicle, data indicating that the OTA software package has been provided to the vehicle at the location.

12. The computing system of claim 1, wherein the control circuit is further configured to:
determine a confidence in the time that the vehicle is estimated to be at the location; and
queue the OTA software package based on the confidence in the time that the vehicle is estimated to be at the location.

13. The computing system of claim 1, wherein the control circuit is further configured to:
obtain network traffic data associated with the network; and
determine a time period for obtaining the OTA software package over the network based on the network traffic data.

14. A computer-implemented method comprising:
obtaining data indicative of a vehicle identifier associated with a vehicle and a time that the vehicle is estimated to be at a location;
determining, based on the vehicle identifier, that an over-the-air (OTA) software package is available for the vehicle;
obtaining, over a network from a remote computing system, the OTA software package for the vehicle based on the vehicle identifier; and
prior to the time that the vehicle is estimated to be at the location, providing the OTA software package to a local cache storage located at the location.

15. The computer-implemented method of claim 14, further comprising:
determining the vehicle has arrived at the location and the vehicle is available for the OTA software package; and
outputting the OTA software package from the local cache storage.

16. The computer-implemented method of claim 14, further comprising:
determining whether the OTA software package for the vehicle is already stored in the local cache storage located at the location.

17. The computer-implemented method of claim 14, further comprising:
providing, to the remote computing system for update of a shadow record of the vehicle, data indicating that the OTA software package has been provided to the vehicle at the location. Page 6

18. The computer-implemented method of claim 14, further comprising:
determining a confidence in the time that the vehicle is estimated to be at the location; and
queuing the OTA software package based on the confidence in the time that the vehicle is estimated to be at the location.

19. The computer-implemented method of claim 14, further comprising:
obtaining network traffic data associated with the network; and
determining a time period for obtaining the OTA software package over the network based on the network traffic data.

20. One or more non-transitory computer-readable media that store instructions that are executable by a control circuit to:
obtain data indicative of a vehicle identifier associated with a vehicle and a time that the vehicle is estimated to be at a location;
determine, based on the vehicle identifier, that an over-the-air (OTA) software package is available for the vehicle;
obtain, over a network from a remote computing system, the OTA software package for the vehicle based on the vehicle identifier; and
prior to the time that the vehicle is estimated to be at the location, provide the OTA software package to a local cache storage located at the location.
